(19) United States
(12) Patent Application Publication
(10) Pub. No.: US 2008/0215348 A1
(43) Pub. Date: Sep. 4, 2008

(54) SYSTEM AND METHODS FOR ADVERTISEMENT AND EVENT PROMOTION

(76) Inventors: Marc Guldimann, San Francisco, CA (US); Anthony Yam, San Francisco, CA (US); Chris Hobbs, San Francisco, CA (US); Ben Kartzman, New York, NY (US); Blythe Dunham, Seattle, WA (US)

Correspondence Address: THELEN REID BROWN RAYSMAN & STEINER LLP, PO BOX 640640, SAN JOSE, CA, 95164-0640, US

(21) Appl. No.: 11/779,721

(22) Filed: Jul. 18, 2007

Related U.S. Application Data
(60) Provisional application No. 60/892,755, filed on Mar. 2, 2007.

(51) Int. Cl. G06Q 30/00

(52) U.S. Cl. 705/1

(57) ABSTRACT

The present invention is directed to a system and methods for targeted advertisement and event promotion. The system comprises a web-based, application which enables event promoters to create, execute and manage event promotional campaigns using advertisements, targeted promotional messages, target user search tools, session tracking tools, campaign analytical tools, event pricing tools, reporting tools, embedded calendar applications and other tools and services provided by the system. The system combines these tools to enable promoters to communicate with and market, events to highly targeted audiences utilizing a wide array of communication tools. Furthermore, each promotional or advertisement campaign enriches and grows promoter's target user list thus continually enlarging the overall group of trusted and targeted system users.

### CROSS-REFERENCE TO RELATED APPLICATIONS

This application is entitled to the benefit of Provisional Patent Application Ser. No. 60/892,755 filed on Mar. 2, 2007, which is incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights.

### FIELD OF THE INVENTION

The present invention relates generally to the field of online marketing and in particular to the system and methods for advertisement and promotion of events to targeted audience.

### BACKGROUND OF THE INVENTION

Advertisement and event promotion is a multibillion dollar business. A success of an event depends in large on the effectiveness of its advertising and/or promotional campaign, which stimulates demand and increase consumer awareness of the promoted event. Traditionally, promotional campaigns were limited to billboard and newspaper advertisements, bulk mailing campaigns and the like. These marketing techniques had limited reach and scope of the audience. Technological developments, however, have enabled advertisers to extend their audience reach using various forms of broadcast medium, such as radio and television. More recently, a growth in computer and telecommunication technologies have added online or Internet-based advertising to the available marketing options.

### SUMMARY OF THE INVENTION

The present invention is directed, to the system and methods for targeted advertisement and event promotion online. The disclosed system and methods enable event customers to maximize reach, exposure and ultimately the success of their events by offering an online event management and promotion system. The system enables customers to effectively run and manage their promotional campaigns using advertisements, targeted promotional messages, target user search tools, session tracking tools, campaign analytical tools, event pricing tools, reporting tools, embedded calendar applications and other tools and services. The system of the present invention combines these tools to enable customers to communicate with and market events to highly targeted audiences utilizing a wide array of communication tools. Furthermore, each promotional or advertisement campaign enriches and grows customer's target user list thus continually enlarging the overall group of trusted and targeted system users.

In an embodiment, the system of the present invention intelligently manages user calendars and event information and allows customers, companies and individuals to build, deploy and manage event information on their websites, intranets, third-party websites and within their e-mail communications. The system enables customers to create event, calendars and to embed them on the customer's websites, social network websites, blogs and other websites, thereby increasing event exposure and the probability of attendance. Users interfacing with the online calendars or embedded calendar components provided by the system can seamlessly add an event to the calendar of their choice (e.g., Microsoft Outlook®, Apple ICal®, Google® Calendar) with just one click. In addition, the users can invite friends to events so they in turn can upload relevant information to their own personal calendars. This unique ability to “virally” spread events utilizing one-click calendar updates and one-click invitations makes the system helpful to customers with gaining additional attendees and visibility to the promoted event.

Once an event has been added to a personal calendar, the system enables customers to correspond directly with any person or group interested in their event. Correspondence might include selling opportunities, discounts, date changes and new events. Should an event date or venue change, the system can globally update all relevant calendar information automatically on various calendar platforms (e.g., Microsoft Outlook®, Apple ICal®, Google® Calendar) insuring consistency and accuracy. Advanced reporting tools allow event customers to have detailed information about users interested in the event. This includes information about user availability, location, age, interests, previously attended events, buying behavior and other factors. The real time reporting functionality allows customers to generate detailed reports to optimize marketing decisions and return on investment (ROI) on promotional campaigns providing unprecedented control over event lifecycles.

In an embodiment, access to the basic functionality of the system may be provided to customers free of charge. This allows customers to easily implement calendar promotions and advertisements where required for one or more events and to track promotional campaigns In real-time. In an embodiment, the customers may be charged for communicating, i.e., promoting events, to the targeted users that were added to the system through previous promotional campaigns. Customers may be billed by the number and type of messages sent, as well as the category of the recipients. In an embodiment, basic reporting may be offered for free while advanced reporting may be offered for a monthly fee. In another embodiment, additional revenue may be generated by selling to third parties advertising space in the promotional messages and event webpages generated through the system. As event details are specific and contextual, the system provides highly target advertising opportunities for third-party advertisers.

The event management and promotional system comprises a plurality of software components that facilitate creation, execution and management of promotional campaigns. In an embodiment, the event management and promotion system includes an interface component, a promotional component, an advertising component, a messaging component, a session component, a reporting component, an analytical component, a pricing component, an accounting component, a calendar component and a database system, which comprises a customer datastore and a target user datastore. The event management and promotion system is connected to and may be accessed by customers, e.g. promoters, and other system users through a packet switched network, such as the Internet. The system is not limited to the above configuration and may include other components and databases in various embodiments.

In one embodiment, the interface component is operable to collect event information from a customer and to store the collected event information in the customer datastore. The calendar component may be used to generate an online calendar to display event information. The promotional component generates an event webpage based at least in part on the collected event information. The webpage may include a script operative to generate a user options menu, which may include add the event to a calendar option, set event reminder option and invite friends to the event option. The advertisement component enables system users to create graphical advertisement creatives of the event based on the collected event information. The advertisement creative may also contain a script operative to generate the user options menu. The messaging component is operable to send to target users a promotional message, which may contain a link to the event webpage. The reporting component generates reports indicating (i) the number of target users who viewed the promotional message, (ii) the number of target users who viewed the event advertisement creative, (iii) the number of target users who viewed the event webpage, (iv) the number of target users who add the event to a calendar, (v) the number of target users who set an event reminder, and (vi) the number of target users who invited one or more friends to the event.

In another embodiment, the messaging component is operative to send event promotional messages to target users. The session component is operative to identify target user responses to the promotional message. The target user response may include (i) viewing the promotional message, (ii) viewing an event webpage, (iii) adding the event to a calendar, (iv) setting an event reminder, or (v) inviting one or more friends to the event. The analytical component is operative to determine target user's interest level in the promoted event based on the target user response to the promotional message. The interest level may be determined based on target user performing one or more of (i) viewing the promotional message, (ii) viewing the event webpage, (iii) adding the event to a calendar, (iv) setting an event reminder, (v) inviting one or more friends to the event, (vi) leaving comments about the event, (vii) uploading media related to the event and (viii) adding the event to their social network. The pricing component is operative to generate customized offers to the target users based on the target user's interest level in the event. The messaging component then generates customized offer messages to the target users based on the customized offers generated by the pricing component.

In addition, the analytical component may be operative to determine whether a number of friends invited to the event by a given target user exceeds a predetermined threshold. The pricing component then generates a customized oiler to the given target user if the number of friends thereof invited to the event exceeds the predetermined threshold. The messaging component then send the customized offer message to the given target user. The session component is also operative to determine whether one or more friends of a given target user have invited one or more friends thereof to the promoted event. The analytical component determines whether a number of friends invited to the event by the friends of the given target user exceeds a predetermined threshold. The pricing component generates a customized offer to the given target user if the number of friends invited to the event by the friends of the given target user exceeds the predetermined threshold. The messaging component then sends a customized offer message to the given target user based on the customized offer.

Yet in another embodiment, a customer who wishes to promote an event may utilize the interface component to enters one or more target user search criteria. The user search criteria may include (i) a genre of the given event, (ii) a venue of the given event, (iii) a date of the given event, and (iv) demographics of intended audience. The analytical component searches the target user database to identify one or more target users whose profiles match the received search criteria. The pricing component determines a price for promoting the given event to the identified target users. In one embodiment, the price for promoting the given event may be based on the target users' interest in similar events, such as events similar in genre to the given event. To that end, the pricing component may retrieve from a target user profiles information indicating the target users' responses to at least one other event promotion. The users responses may include (i) viewing a promotional message of the other event, (ii) viewing a webpage of the other event, (iii) adding the other event to a calendar, (iv) setting a reminder of the other event, or (v) inviting one or more friends to the other event. In another embodiment, the price for promoting the given event to target users may depend on whether a number of friends invited to the other event by the target users exceeds a predetermined threshold. Yet in another embodiment, the price for promoting the given event to target users may depend on whether a number of friends invited to the other event by the friends of the target users exceeds a predetermined threshold. Yet in another embodiment, the price for promoting the given event to target users may depend on whether the target user attended the other event. Having determined the price of promotion, the accounting component collects a payment from the customer for promoting the event to the identified target users. The messaging component then sends promotional message to the identified target users.

Yet in another embodiment, the system allows customers to communicate customized event offers to target users for free, but to charge the customer for communicating with friends of the target users who were discovered by means of the system via promotional campaigns. The system may use a customer-provided contact list of target users is stored in the customer datastore and a system-generated contact list of friends of the target users is stored in the target user datastore. The pricing component determine a price for communicating with friends of the target users. For example, the price for communicating with the friends of the target users may be based on the friends' interest in the event. The pricing component may retrieve from the friends' target user profiles information indicating the friends' responses to the promotional campaign. The response may include (i) viewing a promotional message, (ii) viewing an event webpage, (iii) adding the event, to a calendar, (iv) setting an event reminder, or (v) inviting friends to the other event. Having determined the price for communicating with friends of the target users, the accounting component may collect the required payment from the customer. The customer may then use the messaging component to generate and send customized offer messages target users and friends thereof.

In another embodiment, the system allows system users to share event information between their calendar applications and system-provided embedded calendar components. To that end, the system provides a client component, which may include an instrumentation script executable by the web browser of user computer system. The instrumentation script is operable to identify system users using unique user identifiers placed in the system or web cookies stored on the user computer system. The calendar application or embedded calendar component displays on the user computer system information identifying one or more events, such as an event listing, as well as an indication of a single action that is to be performed by a user to add an identified event to a user calendar. The single action may comprise one of (i) the user clicking of a mouse button when a cursor is positioned over a predefined area of the displayed event information; (ii) the user depressing of a key on a keyboard; and (iii) the user depressing of a key on a television remote control. In response to the single action being performed by the user, calendar application or embedded calendar component is operative to send a request to the server component to add the identified event to one or more user calendars. The request may include a user identifier provided by the instrumentation script.

At the server side, the session component receives the request from the client user computer system. The session component is operative to identify the one or more user calendars based at least on the provided user identifier. The server component may then add the identified event to one or more user calendars. The calendar may comprise a listing of events organized in one of a daily format, weekly format, monthly format, yearly format. The calendar may also comprise an embedded event widget, which displays a list of events organized in chronological order. In one embodiment, calendar may include an online calendar hosted by the calendar component. In another embodiment, the calendar may comprise a calendar script provided by the server component and embedded by the user into a third-party website. Yet in another embodiment, the calendar may comprise a calendar application provided to the user or hosted online by a third party.

In an embodiment, the invention includes a method for promoting events to target user. The method comprising collecting event information from a customer and storing the collected event information in an event database. The method further comprises generating an event webpage based at least in part on the collected event information, wherein the webpage comprises a script operative to generate a user options menu. In an embodiment, the user options menu includes at least an add the event to a calendar option, set event reminder option and invite friends to the event option. The method further comprising generating and sending one or more promotional messages to target users selected by the customer. In an embodiment, the promotional message may include at least a link to the event webpage. Then, in response to user activating the link in the promotional message, providing the event webpage to the user.

The method further comprises, generating a user option menu on the event webpage and receiving user selection. In response to target, user selecting the add event to calendar option, generating a list of calendar applications, in response to target user selecting a calendar application from the generated list, adding the event information to the user-selected calendar. In response to target user selecting the set event reminder option, (i) prompting the target user to indicate a date for sending a reminder message and (ii) sending a reminder message to the target user on the indicated date. In response to target user selecting the invite friends option, (i) prompting the target user to provide contact information for at least one friend and (ii) sending the promotional message to one or more friends of the target user. The method further comprises generating a report indicating one or more of (i) the number of target, users who viewed the promotional message, (ii) the number of target users who viewed the event webpage, (iii) the number of target users who add the event to a calendar, (iv) the number of target users who set ah event reminder, and (v) the number of target users who invited one or more friends to the event.

In another embodiment, the invention includes a method for promoting events to target user. The method comprising collecting event information from a customer and storing the collected event information in the customer datastore. The method further comprises generating a graphical advertisement creative of the event based at least in part on the collected event information, wherein the advertisement creative comprises a script operative to generate a user options menu. In an embodiment, the user options menu includes at least an add the event to a calendar option, set event reminder option and invite friends to the event option. The script may be operative to generate the user options menu in response to a user command, such as (i) user pointing a computer pointing device, such as mouse, over at least a portion of the advertisement creative or (ii) user pointing and clicking a computer pointing device over at least a portion of the advertisement creative. In one embodiment, the method further comprises sending a promotional message to one or more target users, the promotional message containing the advertisement creative embedded therein. In another embodiment, the method comprises providing the advertisement creative for online publishing.

The method further comprises, generating a user option-menu on the event webpage and receiving user selection. In response to target user selecting the add event to calendar option, generating a list of calendar applications. In response to target user selecting a calendar application from the generated list, adding the event information to the user-selected calendar. In response to target user selecting the set event reminder option, (i) prompting the target user to indicate a date for sending a reminder message and (ii) sending a reminder message to the target user on the indicated date. In response to target user selecting the invite friends option, (i) prompting the target user to provide contact information for at least one friend and (ii) sending the promotional message to one or more friends of die target user. The method further comprises generating a report, indicating one or more of (i) the number of target users who viewed the event advertisement, (ii) the number of target users who viewed the event webpage, (iii) the number of target users who added the event to a calendar, (iv) the number of target users who set event reminders, and (v) the number of target users who invited friends.

In one embodiment, the invention includes a method for promoting events to target users. The method comprises sending one or more event promotional messages to one or more target users. The method further comprises receiving, a target user response to the promotional message. A user response to the promotional message may include the user performing one or more of (i) viewing the promotional message, (ii) viewing an event webpage, (iii) adding the event to a calendar, (iv) setting an event reminder, and (v) inviting one or more friends to the event, according to an embodiment of the invention. Based on the target user response to the promotional message, grouping one or more target users into at least a first interest group, second interest group and third interest group. For example, if the target user has added the event to a calendar, set an event reminder or invited one or more friends to the event, the target user may he placed into the first interest group. The target user may be placed into the second interest group if the user only viewed the event webpage. The target users who only viewed the event message are placed into the third interest group. The method further comprises generating and sending customized offer messages to the target users in each, interest group, wherein offers to the target users in each interest group may be different.

In one embodiment, the method further comprises determining whether a number of friends invited to the event by a target user exceeds a predetermined threshold. If the number of friends invited to the event by the given target user exceeds the predetermined threshold, generating and sending a customized offer message to the given target user. In another embodiment, the method further comprises determining whether one or more friends of the given target user invited one or more friends to the event, and if so, determining whether a number of friends invited to the event by the friends of the given target user exceeds a predetermined threshold. If the number of friends invited to the event by the friends of the given target user exceeds the predetermined threshold, generating and sending a customized offer message to the given target user, wherein the custom offer may differ from other offers.

In another embodiment, the invention includes a method for promoting events to target users. The method comprises sending one or more event promotional messages to one or more target users. Base on a target user response to the promotional message, determining target user's interest level in the promoted event. The interest level is determined by assigning a score to the target user based on the user's response to the promotional message. The target user response to the promotional message may include the user performing one or more of viewing the promotional message, viewing an event webpage, adding the event to a calendar, setting an event reminder, and inviting one or more friends to the event. In an embodiment, assigning a score of one to the target user if the target user viewed the promotional message; assigning a score of two to the target user if the target user viewed the event webpage; assigning a score of three to the target user if the target user set an event reminder; assigning a score of four to the target user if the target user added the event to the calendar; and assigning & score of five to the target user if the target user invited one or more friends to the event. In alternative embodiments, other scoring scheme know to those of skill in the art may be used.

The method further comprises generating one or more customized offer messages to the target users based on the target user's interest level in the event and sending the customized offer messages to the target users. In an embodiment, an offer message to the target user may be based on target user's overall score. In another embodiment, an offer message may depend on whether a number of friends invited to the event by a target user exceeds a predetermined threshold. Yet in another embodiment, an offer message may depend on whether a number of friends invited to the event by the friends of the target user exceeds a predetermined threshold.

In an embodiment, the invention includes a method for promoting events to target users based on a user profiles. The method comprises receiving one or more target user search criteria from a customer. The search criteria may include, but are not limited to, genre of the given event, venue of the given event, date of the given event, and demographics of intended audience. The method further comprises searching tire target user datastore for users whose profiles match the received search criteria. For the identified target users retrieving from the target user profile information indicating the target user's response to at least one other event promotion, wherein the other event is at least in genre similar to the given event. The target user's response to other event promotion may includes (i) viewing a promotional message of the other event, (ii) viewing a webpage of the other event, (iii) adding the other event to a calendar, (iv) setting a reminder of the other event, or (v) inviting friends to the other event.

Next, the method comprises determining a price for promoting the given event to one or more target users, wherein the price for promoting the given event to a target user depends at least in part on the target user's response to the other event promotion. In another embodiment, the price for promoting the given event to a target user depends at least in part on whether a number of friends invited to the other event by the target user exceeds a predetermined threshold. Yet in another embodiment, the price for promoting the given event to a target user depends at least in part on whether a number of friends invited to the other event by the friends of the target user exceeds a predetermined threshold. In another embodiment, the price for promoting the given event to a target user depends at least in part on whether the target user attended the other event. The method further comprises receiving a payment from the customer for promoting the given event to the one or more target users. The method further comprises generating and sending promotional messages to the target users.

In another embodiment, a method for sharing event information between system users is disclosed. The method comprises providing to a client system a user identifier. The method further comprises providing to the client system a script operable to display information identifying one or more events and an indication of a single action that is to be performed to add an event to one or more calendars. In response to the single action being performed by a user of the client system, receiving from the script a request to add an identified event to one or more calendars associated with the user of the client system and the user identifier. The method further comprising identifying the one or more calendars associated with the user of the client system based at least on the received user identifier and adding the identified event to one or more identified calendars. Yet in another embodiment, a method for sharing event information comprises displaying at a client system information identifying an event, displaying an indication of a single action that is to be performed by a user to add the identified event to one or more calendars and in response to only the indicated single action being performed by the user, and sending to a server system a request to add the identified event to one or more calendars.

### BRIEF DESCRIPTION Of THE DRAWINGS

The several embodiments are illustrated in the figures of the accompanying drawings which are meant to be exemplary and not limiting, in which like references are intended to refer to like or corresponding parts, and in which:

FIG. 1 is a block diagram depicting an embodiments of the event management and promotion system;

FIG. 2 is a block diagram depicting an embodiment of a database structure of the event management and promotion system:

FIG. 3 is a block diagram depicting an embodiment of a process for collecting session data and generating behaviorally targeted leads;

FIG. 4 is a flow diagram depicting the high level operation of the customer interface of the event management and promotion system:

FIG. 5 is a flow diagram depicting an embodiment of a process for generating event webpages;

FIG. 6 is a flow diagram depicting an embodiment of a process for promoting an event and collecting behaviorally targeted leads data;

FIG. 7 is a flow diagram depicting an embodiment of a process for advertising an event collecting behaviorally targeted leads data;

FIG. 8 is a flow diagram depicting an embodiment of a process for reporting results of promotional campaigns;

FIG. 9 is a flow diagram depicting one embodiment of an interest algorithm of the event management and promotion system;

FIG. 10 is a flow diagram depicting another embodiment of the interest algorithm of the event management and promotion system;

FIG. 11 is a flow diagram depicting a process for event pricing implemented in an embodiment of the event management and promotion system;

FIG. 12 is a graph of an embodiment of a variable pricing model;

FIG. 13 is a flow diagram depicting an embodiment of a process for target user search and targeted event promotion;

FIG. 14 is a flow diagram depicting an embodiment of a process for targeted event promotion;

FIG. 15 is a flow diagram depicting an embodiment of a process for one-click event sharing; and

FIGS. 16-21 are interface diagrams according to various embodiments of the present invention.

### DETAILED DESCRIPTION OF THE EMBODIMENTS

In the following description of the various embodiments of the present invention, reference is made to the accompanying drawings that form, a part hereof, and in which is shown by way of illustration various embodiments of the present invention. If is to be understood that other embodiments may be utilized and structural changes may be made without departing from the scope of the present invention.

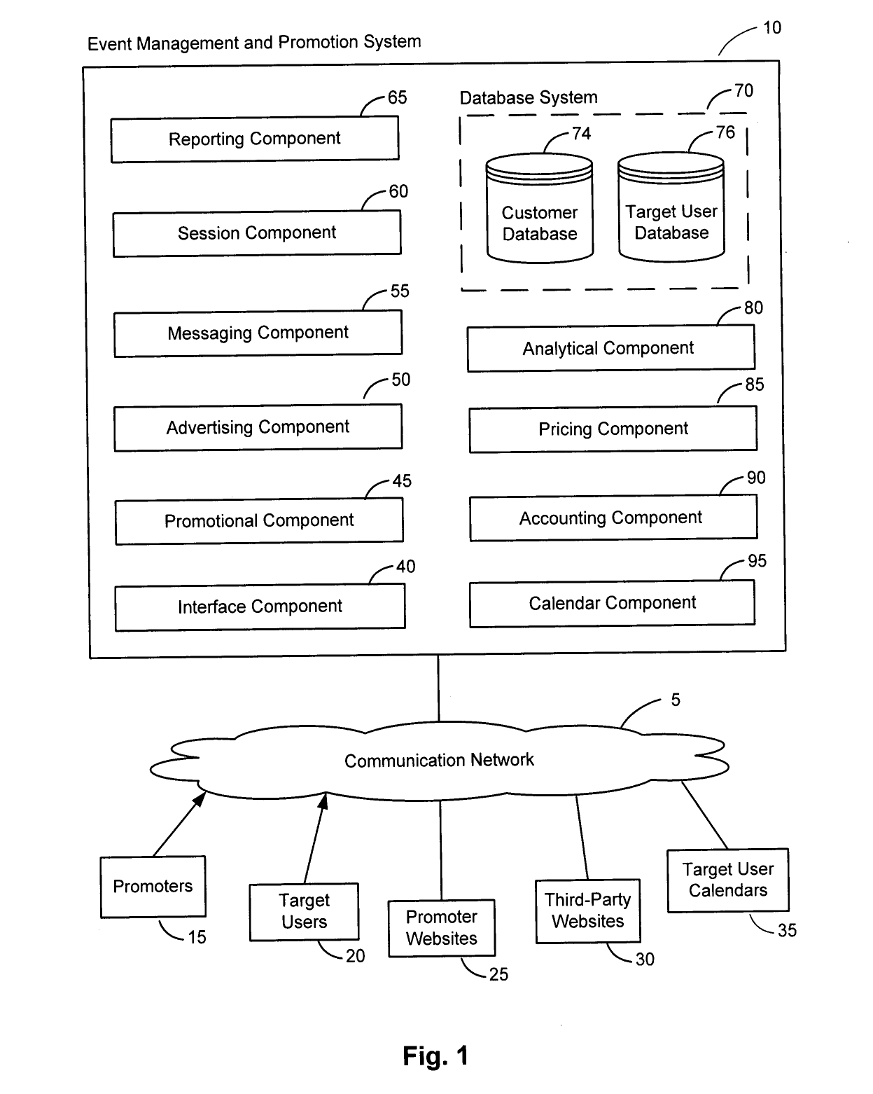

FIG. 1 depicts a block diagram of a networked, communication environment in accordance with one embodiment of the invention. As shown, the communication environment comprises a event management and promotion system 10, which facilitates creation, execution and management of promotional and advertising campaigns. The system 10 may be accessed by system users, such as customers 15 and target users 20 via a packet switched communication network 5, such as the Internet. The customers 15 may include individuals or organizations who represent, sponsor or promote events, performers or venues, and who uses the system 10 to create, execute and manage event promotional campaigns. Target users 20 may be individuals or organizations to whom the events are being promoted to by customers 15 of the system 10. Target users 20 may include customers 15 and vice versa. Events promoted via system 10 may include, but is not limited to, activities that attracts an audience—live or via an electronic medium—for the purpose of providing a common experience for the audience. For example, promoted events may include, but are not Limited to, music concerts, book readings, fine art exhibitions, movie premiers, works of performing art, consumer electronic and auto shows, sporting events and other activities.

In an embodiment, the event management and promotion system 10 may be implemented as an application server based on Ruby on Rails, Microsoft .NET framework. Sun Microsystems J2EE framework or other web application platforms. The system 10 may comprise a plurality of software components that facilitate creation, execution and management of promotional campaigns. As depicted, the system 10 includes an interlace component 40, a promotional component 45, an advertisement component 50, a messaging component 55, a session component 60, a reporting component 65, an analytical component 80, a pricing component 85, an accounting component 90, a calendar component 95 and a database system 70, which comprises a customer datastore 74 and a target user datastore 76. The event management and promotion system 10 may broadly represent all program code, software tools, applications, application program interfaces (API), or other tools used in implementing systems and methods according to various embodiments of the present invention, including systems and methods associated with the creation, execution and management of promotional campaigns. The event management and promotional system 10 is not limited to the above configuration and may include other components and databases in various embodiments on the invention.

Database System

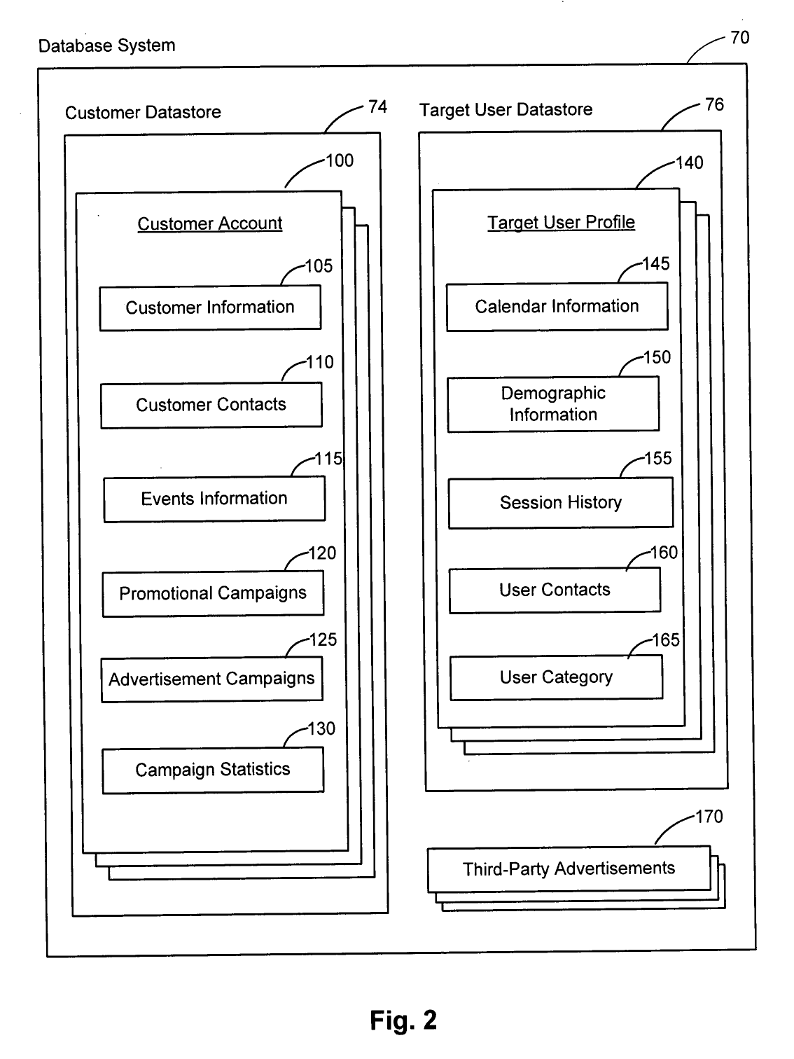

In an embodiment, the event management and promotional system comprises a database system 70. An embodiment of the database system 70 is depicted in FIG. 2. The database system includes a customer datastore 74 and a target user datastore 76. The customer datastore 74 may be used to store one or more customer accounts 100. A customer account 100 is a data structure for storing customer-related information. In an embodiment, each customer account 100 may include customer information 105, such as customer name, account login information, customer contact information and other data. Customer account 100 may also include customer contacts 110, such as a contact list of target users 20. In various embodiment, contacts 110 may include user email addresses, website addresses, phone numbers, postal addresses and other information. The contact list of target users may be provided by the customer 15 or may be generated by the system 10 in the course of various promotional campaigns, as will be described in a greater, detail herein. Customer account 100 may also include event information 115 related one or more events promoted by customer 15. Event information 115 may include description of the event, such as its name, type and genre, as well as event date, time and venue information. In an embodiment, event information 115 may also include demographic information of the intended audience and other information.

In an embodiment, customer account 100 may also include information about one or more promotional campaigns 120, including such information as one or more event webpages, various promotional, invitation and offer messages, a list of target users of the promotional campaign and other campaign-related data. Customer account 100 may also include information about one or more advertisement campaigns 125. This information may include one or more advertisement creatives, a list of advertising channels, such as DoubleClick, Google, Yahoo!, etc. and other information associated therewith. Customer account 100 may also include campaign statistics information 130, including but is not limited to, a number of target users who viewed promotional messages, a number of target users who viewed the event advertisement creative, a number of target users who viewed the event webpage, a number of target users who added the event to a calendar, a number of target users who set event reminders, a number of target users who invited one or more friends to the event and a number of target users who actually attended the promoted event. Customer datastore 74 may contain additional information to facilitate online advertisement and event promotion.

In an embodiment, the target user profile datastore 76 includes a plurality of target user profiles 140, which are data structures for storing target user related information. A user profile 140 may include user's calendar information, such as the types of calendar applications (e.g., Microsoft Outlook®, Apple ICal®, Google® Calendar), user login names and passwords, calendar events information and other types of data. The target user profile 140 may also include user's demographic information 145, including but not limited to user' age, gender, ethnicity, religion, address, marital status, interests, preferences and the like. Target user profile 140 may also include session history data 155 for each event promoted or advertised to the target user 20, such history data 155 may include, but is not limited to, indications of whether the user 20 has viewed promotional messages, viewed event webpages, added event to calendars, set event reminders, invited friends and/or attended the event. The target user profile 140 may also include user contacts list, which includes a contact information of one or more friends of the target user 20, such as their email addresses, phone numbers and the like. The target user profile 140 may also include user category identifier 165, which indicates whether the users is a connector or a maven, as will be described in a greater detail herein. Datastore 76 may contain additional information in various embodiments of the invention.

Yet in another embodiment, the database system 70 may store a plurality of third-party advertisement creatives 170. Advertisement creatives 170 may include markup language documents (e.g., HTML, XML) that comprise text, graphics, multimedia and script elements. In various embodiments, advertisement creatives 170 may include banner ads, interstitial ads, sidebar ads and other types of advertisements know to those of skill in the art. Advertisement creatives 170 maybe provided by third-party advertisers or may be created by customers 15 in connection with their advertising and promotional campaigns. In various embodiment, advertisement creatives 170 may be related to various products or events. The event-related advertisements 170 may be organized in the database system 70 by the customer name, event genre, date/time or venue of the advertised event. In one embodiment, the system 10 may distribute advertisement creatives 170 by, for example, embedding them into promotional messages, event webpages and other campaign materials that are distributed to target users 20. In another embodiment, advertisement creatives 170 may be distributed via placement thereof on the customer websites 25, third-party websites 30 and target user calendars 35.

In an embodiment of the invention, the database system 70 may be a relational or object oriented (OO)/component based database management system, or the like, that controls the storing, retrieving, and updating of data and metadata in the database records. The database management system 70 may also control data integration, enforce integrity rules and constraint (including data integrity and referential integrity), and enforce security constraints. The database system 70 may support the Open DataBase Connectivity (ODBC) or Java DataBase Connectivity (JDBC) protocols. The database system 70 may be a scalable system that stores data on multiple disk arrays. Data warehousing can be implemented with commercially available database software, such as the MySQL database server, the SQL Server 2000 application available from Microsoft Corporation, the ORACLE 1i™ database available from Oracle Corporation, or other commercially available or custom-written database applications known to those skilled in the art.

Interface Component

With reference to FIGS. 1 and 2, the event management and promotion system 10 includes an interface component 40. In one embodiment, the interlace component 40 is hosted on the a Web sewer hosted by the system 10 and connected to the communication network 5. The interface component 40 generates one or more webpages that provide a graphical user interface (GUI), which enables customers 15 to access, the event management and promotion system 10 using their web browser applications. In another embodiment, the interface component 40 may provide to customers 15 one or more application program interfaces (APIs), such as XML-based. APIs. Customers 15 may use the provided API to design custom interactive interfaces to access the event management and promotion system 10 through the communication network 5. In an embodiment, the interface component 40 is operative to provide a login interface to customers 15 who wish to access the system 10. The login interface is operative to validate customer-provided login credentials against customer information 105 stored in the customer account 100 and, if the login credentials are valid, to generate a customer interfaces that enables customer 15 to create, execute and manage their event promotional and advertising campaigns.

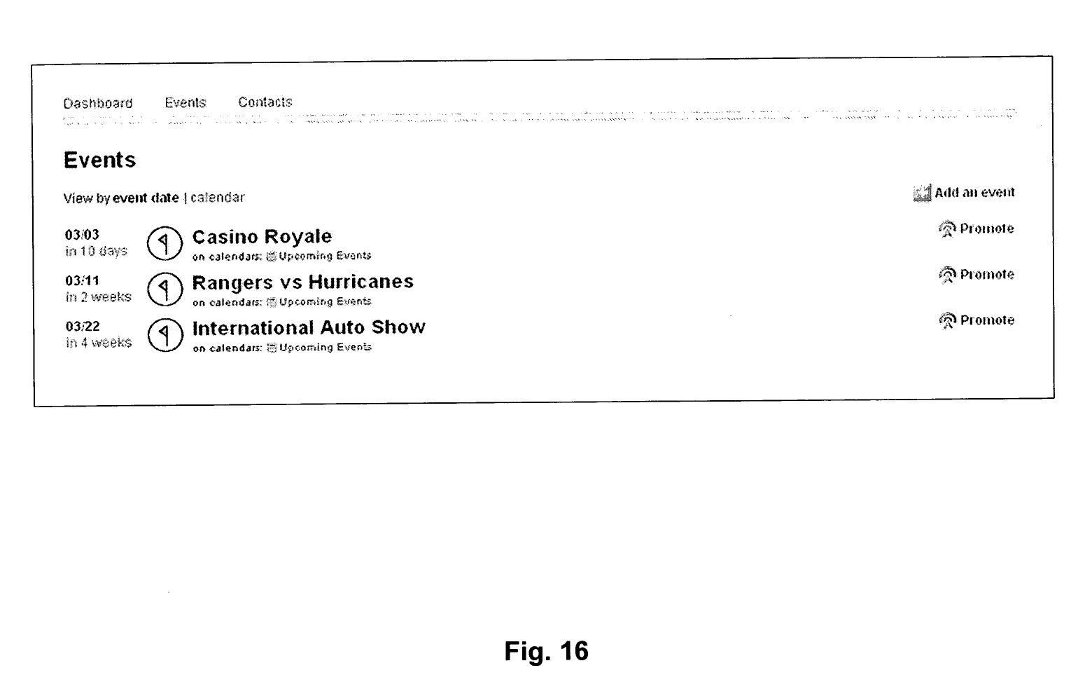

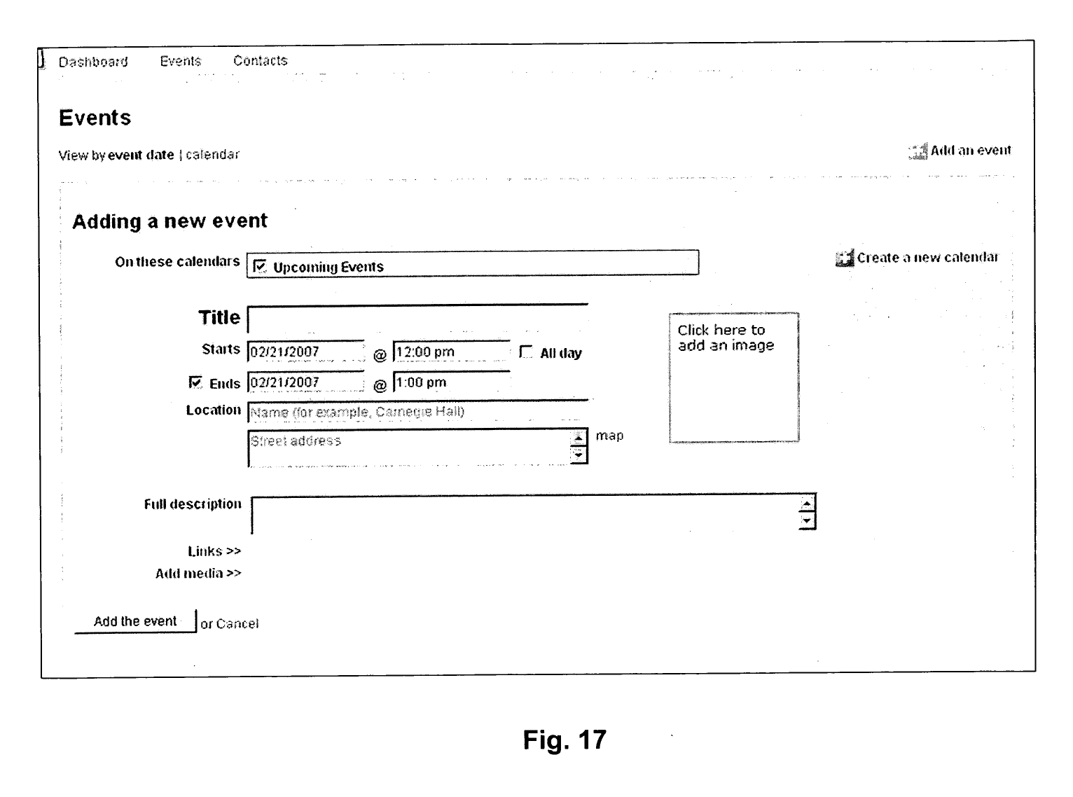

In an embodiment, the interface component 40 may generate a customer interface to display a list of customer events 115 stored in the customer datastore 74; an exemplary customer interface is illustrated in FIG. 16. The displayed events may be ordered chronologically, as depicted, contextually, by venue or using custom tags, as will be described in a greater detail herein. In an embodiment, the interface component 40 provides customer 15 with an option to add new events to the customer account 100. In response to customer's command to add a new event, the interface component 40 may generate an interface for adding new events to the customer account 100; an exemplary embodiment of such an interface is depicted in FIG. 17. The customer 15 may specify the title of the event its start and end time/date, and location of the event. The customer 15 may also provide a description of the event, to upload on the system 10 an image associated with the event, such as a brand image or logo, or upload a multimedia clip associated with the event, such as an audio, video or Flash movie. The interlace component 40 is operative to store the collected event information in the customer account 100 in the customer datastore 74.

In an embodiment, the interface component 40 allows customers 15 to search user profiles 140 in the target user datastore 76 for target users 20 who would be interested in receiving event promotions. To that end, the interface component 40 provides a customer interface that allows customers 15 to enter one or more target user search criteria. The user search criteria may include, but are not limited to, the type of the events that target users are interested in, which may include music concerts, literary readings, automotive shows, movie premiers and other events. The event type search may be further narrowed to concentrate on a genre of the event For example, in the case of music concert, the customer may search for target users interest in jazz, rock, classical music and other music genres. The customer 15 may also search by venue of the event. The venue search, allows customer 15 to search target users by state, city, neighborhood or specific location, such as the Madison Square Garden. The customer 15 may also search target user by their availability on the date of the event, in which, case, the interface component 40 may communicate with the calendar component 95, which stores target user calendar information, to determine whether the target user has other engagements planned for the date and time at which, the given event will take place. In addition, the customer 15 may search target user profiles by user's demographic parameters, such as user age, marital status, ethnicity and other parameters, which may be helpful in determining whether a user may he interested in the promoted event.

In an embodiment, the interface component 45 also provides customers 15 with event and user tagging functionality, which facilitates management of promotional and advertising campaigns. Tags may be implemented as user customized labels that can be created and assigned by a customer 15 to one or more events and/or target users. Event tags may he used to organize customer events into groups based on various criteria, so that events can be easily searched and displayed. The event tags may specify genre of the event, venue of the event, performer's name, importance, revenue and various other parameters. Thus, a customer 15 may for example, tag several events from his entire event list as “high importance” and several other events as “Bon Jovi”. In an embodiment, a single event may have several tags associated therewith, thereby placing it in several different groups. Accordingly, the customer 15 may utilize interface component 45 and its event tagging feature to search through his event listing for events marked with particular tags. In another embodiment, customer 15 may also tag target users in customer contacts 110. The user tags may include, for example, a maven tag, a connector tag, a VIP tag, an artist tag (e.g., Bon Jovi) and other tags. The customer 15 may then use user tags to identify users who should receive event promotions and special offer messages. The tagging functionality is not limited to event and user tagging and other uses of tags are within the scope of the present invention.

Promotional Component

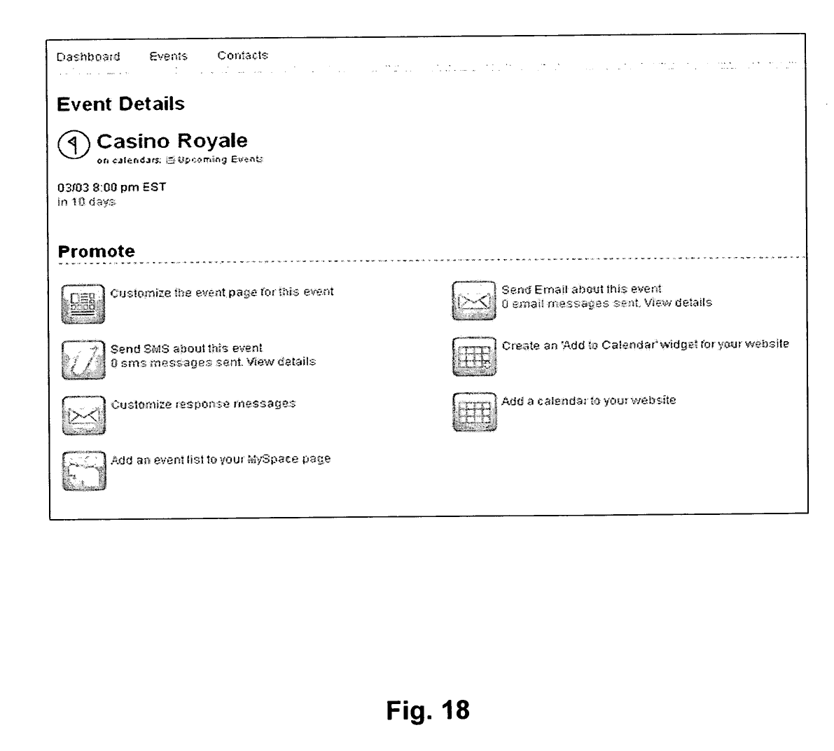

In an embodiment, the event management and promotion system 10 comprises a promotional component 45 that facilitates promotion of customer events to target users 20. Event promotion may be accomplished via targeted promotional messages, event webpages, as well as calendar promotions and event listings on the customers websites 25 and third-party websites 30. To that end, the promotional component 45 is operative to generate a promotional interface that lists available promotional options; an exemplary promotional interface is depicted in FIG. 18. In an embodiment, the promotional interface may be generated in response to customer selecting “promote event” option from the customer event interface, such as the one depicted in FIG. 16. In an embodiment, the available promotional options include, but are not limited to, customize event webpage, send text (e.g., SMS) message, customize response message, add an event page to a third-party website 30, such as MySpace.com, send email about the event, create an “add to calendar” (or “add to life”) event widget for customer website 25, and add a calendar to customer website 25. These promotional, options will be described in a greater detail herein in connection with various system components.

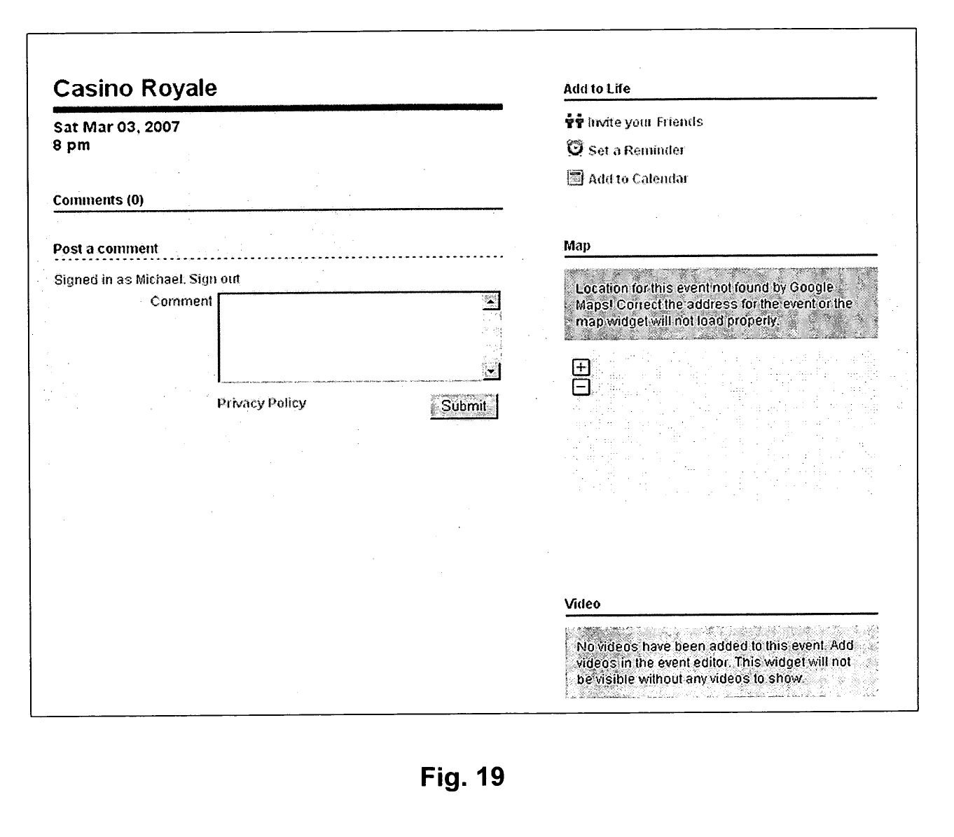

In an embodiment, the promotional component 45 may facilitate event promotion via customized event webpages; an exemplary embodiment of an event webpage is depicted in FIG. 19. In an embodiment, the even webpage may be generated from a HTML document template, which is populated with event information 115 provided by the customer 15 and stored in a customer account 100 in the datastore 74. As depicted, the event webpage may include a title of the event, its date and time, a description of the event, images, audio or video presentations associated with the event, a map of the area where the event will take place, and a comments entry field, which allows users to submit their comments and event reviews. In an embodiment, the event webpage may contain a link to a website of an authorized ticket vendor, where the user can purchase admission tickets. In another embodiment, the event webpage may also include an Add to Life™ (ATL) options menu, which may include the following options: set event reminder, invite friends and add event to a calendar. The operation of the ATL menu will he described in a greater detail hereinbelow. In one embodiment, customized event webpages may be stored in the customer datastore 74 and accessed by target users 20 through interlace component 40 as will be described in a greater detail hereinbelow. In another embodiment, customized event webpages may be stored and hosted from customer websites 25, in which case, event webpages may also include HTML tags that facilitate collection of user's browsing session information on the customer website 25, as will be described in greater detail hereinbelow in connection with operation of the session component 60.

As indicated above, one feature of the event webpage is the Add to Life™ (ATL) options menu. The ATL menu may be generated by a script (the “ATL script”). The ATL script may comprise a Java Applet, JavaScript code, a CGI code, a Macromedia Flash component, an XML script or other type of computer program code. In an embodiment, the ATL menu may include the following options; add event to a calendar, set event reminder, and invite friends to the event. The set a reminder option enables the user to indicate user contact address, such as an email address or mobile phone number, and date when an event reminder is to be send to the user. The ATL script records reminder information in the customer account 100 or target user profile 140. On the indicated date/time, the promotional component 45 may Instruct the messaging component 55 to send an event reminder message, such as an email or text message, to the target user 20. The invite friends option enables the user to send invitation messages to one or more friends. In particular, the user may specify friends' contact information, and the ATL script instructs the messaging component 55 to send promotional messages to identified friends. The add to calendar option enables the user to add an event entry to his calendar application. In particular, the ATL script may generate a list of available calendar applications (e.g., Microsoft Outlook®, Apple iCal®, Google® Calendar) and instruct the calendar component 95 to add the event information to the user-selected calendar, as will be described in a greater detail herein in connection the calendar component 95. In other embodiments, the ATL menu may include fewer or more options; for example, a Subscription option may be provided, which instructs the promotional component 45 to keep the user updated on the various events associated with the particular performer or venue. Yet in other embodiments, the various ATL features may be combined or separated into fewer or more user options, and may be activated through a single or multiple actions by the user, as will be described in a greater detail herein.

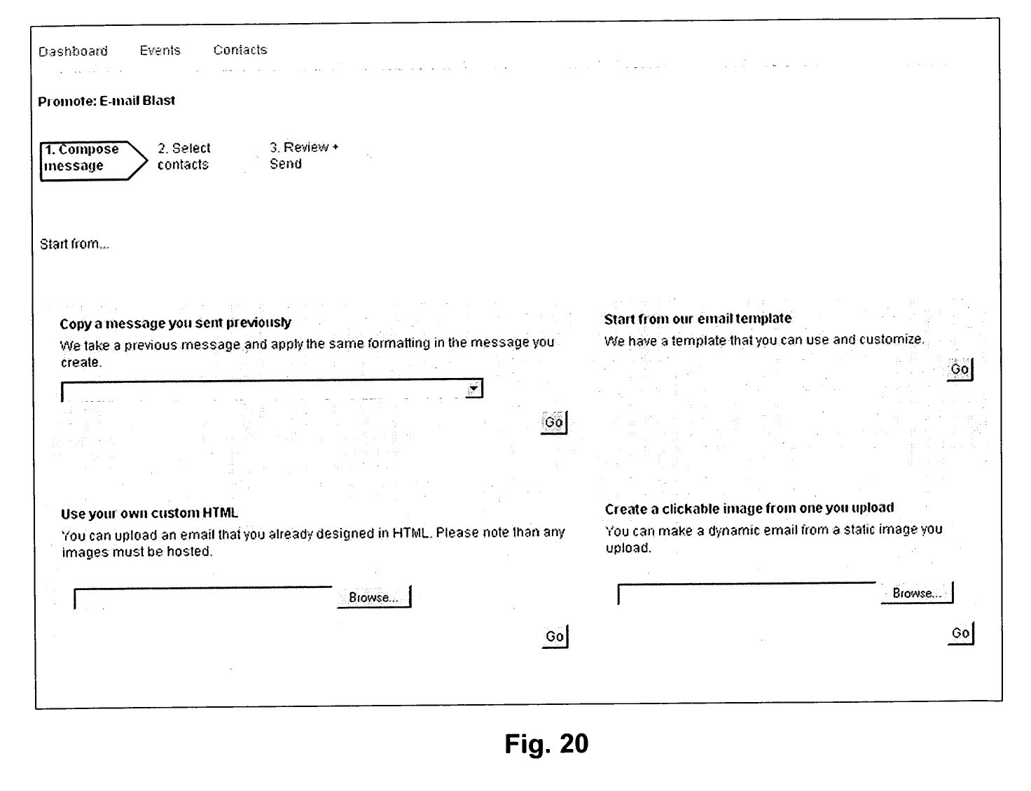

In an embodiment, the promotional component 45 may facilitate event promotion using promotional messages, as indicated in FIG. 18. A promotional message may include, but is not limited to, an email message, a text message, an instant message or other types of electronic messages. To generate a message, die promotional component 45 provides a customer interface that may be used by the customer to create customized promotional messages; an exemplary interface is depicted in FIG. 20. The process of creating customized promotional messages is described in a greater detail herein in connection with the messaging component 55. In one embodiment, promotional messages may include information about the promoted event. In another embodiment, promotional messages may include a URL of the event webpage, whereby the user can access event webpage to obtain addition information about the promoted event. Yet in another embodiment, promotional messages may contain advertisement of the event, such as those created using the advertisement component 50, as will be described in a greater detail herein in connection with the advertisement component 50.

In an embodiment the promotional component 45 may facilitate event promotion using calendar promotions through customer websites 25, as indicated in FIG. 18. There are at least two way to implement the calendar promotions. First, the promotional component 45 provides a calendar code, which a customer 15 may embedded into customer website 25. The calendar is operable to retrieve event information 115 from the customer account 100 and to display it in daily, weekly, monthly or yearly format. Thus, visitors of the customer website 25 may view event information in the embedded calendar. Second, the customer 15 may choose to utilize a calendar provided by the calendar component 95 and hosted on the Web servers of the event management and promotional system 10. Thus, visitors of the customer website 25 may be redirected to a calendar hosted on the system 10 to view event information 115. In an embodiment, both the embedded calendar and system calendar may include ATL scripts, which enable visitors to add events to calendars, set event reminders and invite friends.

In an embodiment, the promotional component 45 may facilitate event promotion using event listings on the customer websites 25 and third-party websites 30, as indicated in FIG. 18. To that end, the promotional component 45 provides customer 15 with an event widget, which is a script program that may be embedded by the customer 15 into customer website 25 or third-party website 30, such as MySpace.com. The embedded event widget is operable to retrieve through the calendar component 95 the customer event information 115 and to generate a list of the customer events on the customer website 25 and third-party website 30. The functionality of an event widget will be described in a greater detail herein in connection with the calendar component 95. In an embodiment, the embedded event widget may include an ATL script that generates an ATL menu for each listed event. Using the ATL menu the visitors can add events to their calendars, set event reminders and invite friends.

Advertisement Component

In an embodiment, the event management and promotion system 10 includes an advertisement component 50, which facilitates advertisement of events. In particular, the advertisement component 50 is operable to generate and distribute advertisement creatives based on event information provided by customer 15 and other data. In one embodiment, the advertisement component 50 provides a customer interface for generating advertisement creatives. The advertisements may include images, audio, video, Java applets and Macromedia Flash® elements. The customer 15 may also specify the way in which the newly generated advertisement creatives are to be distributed, such as banner advertisement. Interstitial advertisement, side-bar advertisement or email advertisement. The customer 15 may also specify where advertisement creatives 125 are to be displayed, including but not limited to promotional messages, customer websites 25, third-party websites 30 and the like. The advertisement component 50 may then store advertisement creatives 125 along with customer's advertisement preferences in the customer datastore 74. The advertisement component 50 may then distribute advertisement creatives 125 in a manner specified by the customer 15.

In an embodiment, the advertisement component 50 in connection with other system components may facilitate distribution of advertisement creatives 125 as well as third-party advertisements 170. The advertisement creative 125, 170 may be distributed as email advertisements, side-bar advertisement, banner advertisements, interstitial advertisements or using other distribution/presentation techniques. In one embodiment, the advertisement component 50 in connection with the promotional component 45 and messaging component 55 may facilitate distribution of advertisements 125, 170 within promotional messages, which may be send to targeted users as part of promotional campaigns. In another embodiment, the advertisement component 50 may place advertisement creatives 125, 170 on side bars of the event webpages, calendars and, with customer's consent, on the customer websites 25. In another embodiment, the advertisement component 50 may place advertisement creatives 125, 170 on the customer website 25 to be displayed as banner and interstitial advertisements. Yet in another embodiment, the advertisement component 50 may provide advertisement creatives 125, 170 for distribution by advertising channels, such as DoubleClick, Yahoo! and Google.

In an embodiment, customer advertisements 125 and third-party advertisements 170 may be inserted into promotional materials randomly, contextually, and/or geographically. In a random advertisement placement, advertisements 125, 170 may be inserted into, for instance, promotional messages regardless of the subject matter of the promoted event. In a contextual advertisement placement, advertisements 125, 170 may be inserted into promotional messages that contextually relate to the subject matter of the advertisements. For example, a promotional message related to an upcoming consumer electronic show may include ads from manufactures and distributors of consumer electronics and advertisements of consumer electronic magazines and websites, such as CNET.com and the like. In a geographic advertisement placement, only advertisements 125, 170 of products and events geographically related to the promoted event are inserted into promotional messages. For example, a promotional message of an event conducted in Madison Square Garden, N.Y., may include advertisements of local restaurants and bars, parking garages and gift shops. In a geo-contextual advertisement placement, advertisements 125, 170 that are geographically and contextually related to the promoted event arc inserted into promotional messages. For instance, a promotional message related to an upcoming auto show may include advertisements of local car dealerships, auto insurance providers and local auto repair shops. Yet in another embodiment, the advertisement component 50 may display advertisements 125, 170 based on the preferences and/or interests of the advertisement viewer, provided that the system first identifies, using techniques described herein, that the viewer is a registered system user. Other advertisement techniques know to those of skill in the art may be used in various embodiments of the invention.

In an embodiment, the advertisement component 50 is operable to add an ATL functionality to the customer-generated advertisement creatives 125 as well as to third-party advertisements 170. For instance, through a customer interface for generating advertisement creatives, the advertisement component 50 may allow customer 15 to upload an image of the advertisement creative into an advertisement template. The advertisement template may have an ATL script embedded therein. The customer 15 may then select a section of the image (or the entire image) using his computer pointing device, such as a mouse. The component 50 then associates the selected advertisement section with the embedded ATL script using, for example, HTML Image Maps or other known techniques. The ATL script is operable to generate an ATL menu when a viewer of the advertisement moves a mouse over or clicks on the selected advertisement section. The ATL script enables an advertisement viewer to add the advertised event to calendars, set event reminders or invite friends to the advertised event. Similar processes may be used to add the ATL functionality to third-party advertisements 170.

Messaging Component

In an embodiment, the event management and promotion system 10 includes a messaging component 55 operable to generate and send messages to target users 20 using various messaging technologies, including but not limited to, email, instant messaging, text messaging and the like. To facilitate email messaging, the messaging component 55 may utilize Ruby on Rails ActionMail or JavaMail™ APIs, winch enables messaging using various message access protocol's, such as POP3 and IMAP, and message transfer protocols like SMTP; other email technologies known to those of skill in the art may be used in various embodiments of the invention. To facilitate instant messaging, the messaging component 55 may utilize Ruby or Java APIs for AOL® Instant Messenger (AIM). Yahoo! Instant Messenger, MSN Instant Messenger, and the like to generate and send instant messages. To facilitate text messaging, the messaging component 55 may utilize Short Message Service (SMS), Multimedia Messaging Service (MMS), Enhanced Messaging Service (EMS) and the like to send text messages to target users' mobile devices.

In an embodiment, the messaging component is operable to generate promotional messages, invitation messages and offer messages. In one embodiment, a promotional message may include information about the promoted event, such as a title, date, venue, description of the event and a URL to the customer's webpage 25. In another embodiment, a promotional message may include a URL of the event webpage, whereby the recipient of the message may access the event webpage to obtain addition information about the promoted event, purchase tickets, and the like. Yet in another embodiment, a promotional message may contain customer-generated advertisement creatives 125 and/or third-party advertisement creatives 170, which may be provided by the advertisement component 50. In an embodiment, a user may send an invitation to the event to one or more friends using invitation messages. An invitation message may include an indication of the user (e.g., user's name) who initiated the invitation and a URL of the event web page. In another embodiment, the customer may send event offers to target user using offer messages. An offer message may include event offer information, such as prices of an admission ticket, special promotions and other information.

In an embodiment, the messaging component 55 facilitates creation of promotional messages in connection with promotion of one or more events. To that end, the messaging component 55 generates a customer interface, such as a messaging interface depicted in FIG. 19, which enables customer 15 to create promotional messages. The messaging interface provides several messaging options to the customer 15. For instance, the messaging interface enables the customer to apply previously created message formats to the current promotional message. The message format information maybe stored in a customer account 100 of the customer datastore 74. Alternatively, the customer 15 may use the system-generated message templates provided by the messaging component 55. The customer 15 may also upload to the system 10 his own HTML messages to be used for event promotion. In addition, the messaging component 55 enables customers 15 to create dynamic emails that include clickable images and advertisements using, for example, processes described herein in connection with the advertisement component 50.

In other embodiments, the messaging component 50 is operable to generate invitation and offer messages. In one embodiment, the messaging component 50 creates invitation messages pursuant to a request from an ATL script. As indicated, the ATL script generates an ATL options menu, which includes inter alia an option to invite friends to the event. Once a user selects this option, the ATL script communicates with the messaging component 50, which in response generates a user interface by means of which the user may provide friends' contact information, such as email addresses, and enter text to be placed in the body of the message. Having collected this information, the messaging component 50 is operative to generate invitation messages and send them to the indicated friends. In another embodiment, the messaging component 50 in connection with the pricing component 85 is operable to generate and send custom offer messages to target users 20. The offer messages include custom offer information generated by the pricing component 50, as will be descried in a greater detail herein. The functionality of the messaging component 50 is not limited to that described herein but may include other aspects in various embodiments of the invention.

Calendar Component

In an embodiment, the event management and promotion system 10 includes a calendar component 95 operable to provide event calendars and other event management components to the system users. In one embodiment, the calendar component 95 may host on the system's Web server an online calendar application, which may be used by system users to maintain and manage their personal information, such as events, engagements and contacts, in a secure and readily accessible environment. The access to the online calendar may be provided free of charge to users who have accounts on the system 10. In an embodiment, only account users may access, view and edit their online calendars and information stored therein. In an embodiment, the calendar application may also include and the ATL functionality. For example, by right-clicking on a calendar entry, a calendar user may activate an ATL menu, which enables the user to add the event to user's other calendars, set reminders and invite friends. The online calendar application may have other functions described herein.

In an embodiment the calendar component 95 facilitates event promotion via the online calendar application. In particular, customers 15 may use online calendar provided by the calendar component 95 for promoting customer events 115 stored in customer accounts 100. The promotional functionality may be provided to customers 15 free of charge or for a fee. In particular, a customer 15 may add new events to the customer account 110 and create event webpages, as described in a greater detail herein in connection with the interface component 40 and promotional component 45. The customer 15 may then add to his websites 25 or third-party websites 30 a link to the online calendar hosted by the system 10. Visitors of the websites 25, 30 may follow the link to the online calendar provided by the calendar component 95 to view customer events 115 in a calendar format, such as daily, weekly, monthly and yearly view. Furthermore, by clicking on the calendar entries, the visitors may view event webpages, which provide detailed event information. The online calendar may also include ATL functionality. For example, by right-clicking on a calendar entry, the user may activate an ATL menu, which would enable the user to add an event to the user's calendar, set reminders and invite friends. The online calendar may have other features as well.

In an embodiment, the calendar component 95 may provide customized calendars, which may be embedded into a customer website 25. In particular, the calendar component 95 provides a customized calendar program code, which may be embedded by the customer 15 into the website 25. The calendars may be graphically and stylistically customized to match the color scheme and layout of the customer website 25. When a user visits the website 25, the script is operable to generate a customized online calendar using, for example, HTML, Cascading Style Sheets (CSS), Macromedia flash® and other techniques, and populate it with event information 115 retrieved from the customer account 100 of the datastore 74 using, for example, Common Gateway Interface (CGI), Active Server Pages (ASP) or other technologies know in the art. In an embodiment, the customer 15 may also customize functionality provided by the embedded calendar. For example, the customer 15 may change the calendar view to a daily, weekly, monthly or yearly format. The customer 15 may add the ATL functionality to the embedded calendar, so that the website visitors may add events to their personal calendars, set event reminders and invite friends. The list of customizable features is not limiting and to the embedded calendar may have other features know to those of skill in the art.

In an embodiment, the calendar component 95 is operable to generate and provide to the system users various event widgets, which facilitate sharing of event information. An even widget may be implemented as a script program, such as a Java Applet, JavaScript code, a CGI code, an XML script, a DHTML code, Ruby on Rails code, a Macromedia Flash® and ColdFusion® program or other type of computer-executable program. The provided event widgets may be embedded by system users into their websites, such as customer websites 25 or third-party websites 30, such as MySpace.com and various other social networking websites and the like. Once a user's website with, an event widget embedded therein in loaded in to a visitor's web browser, an embedded event widget is operable to retrieve from a customer account 100 customer's event information 115 and to display a list of customer's events. In addition, the event widget may display a listing of people who are attending the event. Furthermore, if the viewer is determined to be a registered system user, the event widget may display a list of friends of the viewer who are either attending or not attending the event.

In an embodiment, the event widget may also facilitate sharing of event information among system users. For example, the event widget may include the ATL functionality, which enables the visitors of customer websites to add the displayed events to their own calendars, set event reminders and invite friends to the event. In a particular embodiment, which will be described in a greater detail hereinbelow, an event widget allows system users visiting customer website to add the displayed events to their personal calendars and websites by means of a single action, such as one click of the computer mouse. Likewise, the system users can invite any of their friends with a single or several clicks of a mouse. The calendar component 95 may automatically update user profiles 140 of the invited friends with the event Information and have the event added to their widgets. These arid other functions of event widget will be described in detail herein in connection with the session component 60.

As indicated, the calendar component 95 facilitates information sharing between disparate calendar applications and embedded event widgets. To that end, the calendar component 95 is operable to communicate through a plurality of API with other calendar platforms, such as Microsoft Outlook®, Apple ICal®, Google® Calendar and the like. This allows system users to seamlessly import and export event and contacts information to and from disparate calendar platforms as well as to add event information to their personal calendars directly from event webpages, advertisement creatives, customer websites 25 and third-party websites 30. For example, when a user selects the add event to calendar feature of a calendar embedded in a customer website 25, the calendar script sends a request to the calendar component 95 to add the selected event to the user-specified calendar. The calendar component 95 utilizes APIs of the user-specified calendar and user-provided login information to add the selected event to the user-specified calendar. If the user has an account on the system 10, the calendar component 95 may also store the selected event in the user account and update event information in user's embedded calendars and event widgets accordingly,

Session Component

In an embodiment, the event management and promotion system 10 includes a session component 60 operative to facilitate identification of system users and collection of users' browsing session information. In one embodiment, the session component 60 is operable to identify recipients of promotional messages, viewers of event advertisements, and visitors of event webpages, customer websites 25 and third-party websites 30. The session component 60 may use web browser cookies, system cookies, usernames, user IP addresses, email addresses, message IDs, HTML tags, instrumentations scripts and other techniques know to those of skill in the art to identify system users, as will be described in a greater detail herein. In another embodiment, the session component 60 facilitates collection of information about user's behavior in interaction with various promotional and adverting features of the system 10. The collected information may include, but is not limited to, (i) user's selection of ATL options, such as adding event to a calendar, setting event reminders and inviting friends, and (ii) user's actions with respect to promotional and invitation messages, such as viewing, rewarding or discarding these messages. The session component 60 may collect other types of session information know to those of skill in the art. The session component 60 may then store the collected session information in the target user datastore 76 for further processing.

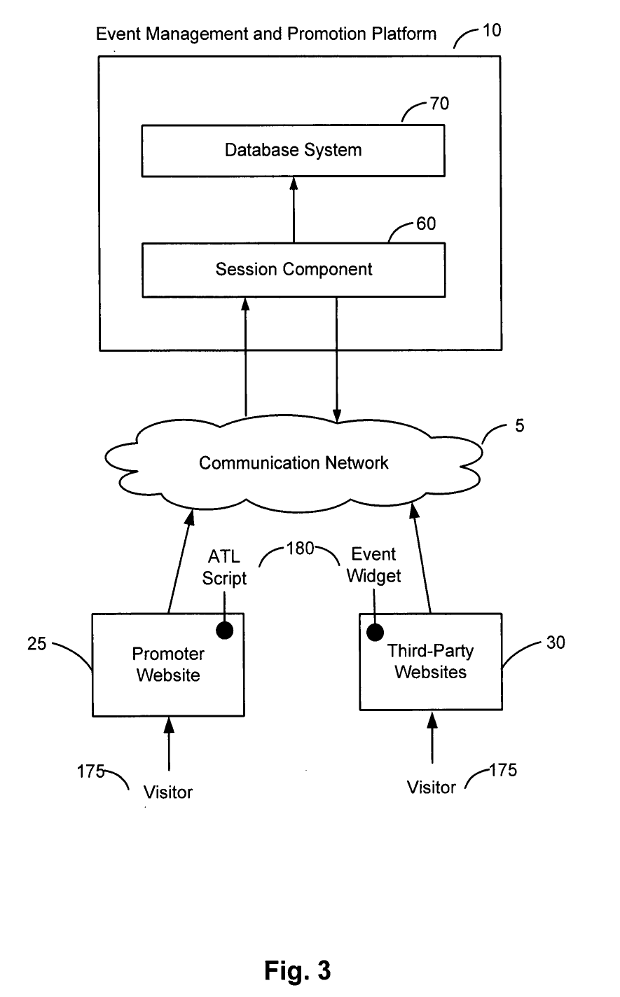

In an embodiment, the session component 60 may use cookies to identify system users and to collect session information; this technique is illustrated in FIG. 3. As depicted, the session component 60 may use system cookies in one embodiment of the invention. The system cookies are provided to registered system users 175 who have accounts on the system 10. A system cookie contains, inter alia, a unique user identifier (“user ID”) that identifies the user 175 to the system 10 when the user 175 browses on a customer website 25, third-party website 30 or other websites, such as those containing advertisement creatives, which contain embedded system components 180, such as ATL scripts, event widgets, embedded calendars and the like. When a webpage (or an advertisement creative) containing an embedded system component 180 is loaded into the user's web browser, the embedded component 180 may send a request to the session component 60, in response to which the session component 60 would return an instrumentation script. The script is operable to determine whether a system cookies is stored in the browser files. If a system cookie is stored, which indicates that the user is a registered system user, the instrumentation scripts may retrieve from the cookie a unique user ID and returns it to the session component 60. The instrumentation script is further operable to collect user's browsing session information and to report tire same to the session component 60, which may store the received information in the customer datastore 74 and/or target user datastore 76. When the user's web browser leaves the webpage, the script may be halted, preventing further data collection. The script may remain dormant in the web browser's memory until the user access another webpage that contains an embedded system component.

In an embodiment, the session component 60 may use web browser cookies to identify users who do not have accounts on the system 10. Similar to a system cookie, the web browser cookie may contains, inter alia, a unique user identifier (“user ID”) that identifies the user 175 to the system 10 when the user browses on a customer website 25, third-party website 30 or any other website that contains embedded system components 180, such as ATL scripts, event widgets, embedded calendars and the like. As described, when a webpage containing an embedded system component 180 is loaded into the user's web browser, the embedded component 180 requests an instrumentation script from the session component 60. The script determines whether a system cookies is stored in the browser files. A user who does not have an account 100 or profile 140 may not have system cookies stored on his computer system. In this case, the instrumentation script generates and stores in the browser memory a web browser cookie that contains a unique user ID. The script may also send the user ID, as well as other user identifying data, such as user's computer IP address or other information, to the session component 60, which may create a user profile 140 based on the available user information. If the user 175 subsequently interacts with the embedded system component, such as utilize its ATL features, and as a result provides additional user information, such as user email address, user calendar information, friend's addresses the like, the embedded component 180 may forward this information to the session component 60 to be stored in the user profile 140. If the user 175 subsequently creates an account on the system 10, the web browser cookie may be replaced with a system cookie on the user's computer system.

In an embodiment, the session component 60 may identify system users using user-provided username or email address. Again with reference to FIG. 3, customer websites 25, third-party websites 30, event webpages, as well as system-generated advertisements and promotional messages may include various embedded system components 180, such as embedded ATL scripts, embedded event widgets and embedded calendars. Upon activation of a system component 180 by a user 175, such as the user clicking on or moving computer mouse over an ATL menu, event listing or embedded calendar, the activated component 180 may prompt the user 175 to provide his/her system username, which identifies registered system users. The embedded component 180 then sends the provided username to the session component 60, which determines if the user 175 has a customer account 100 or user profile 140 on the system 10. If the user 175 is registered, the session component 60 instructs the embedded component 180 to allow the user 175 to use functionality requested by the user, such as add event to calendars, set event reminders and invite friends to the event. However, if the user 175 is not registered, the embedded component 180 may prompt the user to create an account on the event management and promotional system 10 before the user can utilize functionality provided by the embedded component 180 and other features of the system 10.

In another embodiment, the activated component 180 may provide the requested functionality to the user 175 regardless of user's registration status and to identify user in the following manner: First, if the user 175 chooses to add an event to a calendar, the embedded component 180 may forward the user-provided calendar information along with the user login information to the session component 60, which may crosschecks it against target user profiles 140, thereby identifying if the user 175 is registered. Second, if the user 175 chooses to set a reminder, the embedded component 180 may prompt the user 175 to provide an email address to which a reminder should be sent, and then forward the user-provided email address to the session component 60, which may crosschecks it against target user profiles 140, thereby identifying if the user is registered. Third, if the user 175 chooses to invite friends to the event, the embedded component 180 may prompt the user 175 to provide her email address and email addresses of her friends, and then forward the user-provided email address to the session component 60, which may crosschecks it against target user profiles 140, thereby identifying if the user 175 is registered. If the user 175 is not registered, the session component 60 may create a hew user profile 140 based on the information available about the user 175.

In an embodiment, the session component 60 is operable to determine whether promotional, invitation and offer messages as well as event webpages have been viewed by target users. As indicated, a message may include email messages, text messages, instant message and the like. The session component 60 is operable to assign unique message keys to outgoing messages. The messaging component 55 may encode the assigned message key into a URL, which is placed in a HTML tag inserted into the promotional or invitation message. In one embodiment, the message key may be placed into an image URL in a HTML IMG tag that requests a 1×1 pixel image (which is invisible to a human, eye) from the session component 60. When the promotional, invitation or offer message is opened by a target user, an IMG request containing the message key is sent to the session component 60, thereby indicating that the message has been viewed by the target user. In another embodiment, the messaging key may be placed into a document URL in a HTML HREF tag (i.e., hyperlink tag), such as a link to an event webpage. Thus, when the target user clicks the event webpage hyperlink in the promotional message, the message key is send along with the webpage request to the session component 60, thus indicating that the even webpage has been viewed.

In an embodiment, the session component 60 is operable, to determine whether a promotional or invitation message has been forwarded by a recipient to one or more friend users. As indicated, a promotional or invitation message includes a unique message key, which identifies the message to the session component 60. When a target user opens the received message, the message key is communicated to the session component 60 as part of an image request. The session component 60 may send in response to the image request an instrumentation script, which may by cached on the target user's computers system. The instrumentation script is operable to collect user behavior information and communicate it back to the session component 60 using, for example, 1×1 pixel image requests. Therefore, if the target user decides to forward the promotional or invitation message to one or more friends, the instrumentation script is operable to detect this action and communicate it to the session component 60. The instrumentation script may also communicate to the session component 60 email addresses of the friends to whom the message is being forwarded. Once the forwarded message is opened by a friend user, the above-described process is repeated on the friend's computer system. A cached instrumentation script then collects information about the friend user and communicates it back to the session component 60. In this manner, the session component 60 builds a network of users who are interested in the promoted event.

In an embodiment, the session component 60 may facilitates event sharing among system users by means of a single user action, such as one click of a mouse button or depression of a keyboard or remote control key. As indicated, the session component 60 allows system users to add events from other user calendars to their own calendars by, for example, activating an ATL menu and clicking on the add to calendar option. In some embodiments, the ATL menu may comprise a slide up/down menu, which automatically appears when a user moves his mouse over a calendar entry. The user may click on the add to calendar menu option. The ATL script (or a previously loaded instrumentation script), may determine whether the web browser of the user computer system contains a system cookie, which contains a user ID. The script then extracts user ID from the system cookie and forwards it to the session component 60 along with the request to add the selected event to the user calendars. In the request; the user-selected event may be identified by a unique event identifier. The session component 60 identifies the target user profile or the customer account associated with the provided user ID, and, in particular, which calendar applications and embedded event widgets are used by the user. The session component 60 in connection with the calendar component 93 then adds the user-selected event to the identified user calendars and embedded event widgets. In this manner, event information may be shared among system users by means of a single user action, such as a click of a mouse button.

In another embodiment, the session component 60 may facilitate event sharing by means of one-click event invitations. As indicated, the session component 60 allows system users to invite friends to the event by, for example, activating an ATL menu and clicking on the invite friends option. In some embodiments, the ATL menu may comprise a slide up/down menu, which automatically appears when a user moves his mouse over a calendar entry. The user may click on the invite friends, menu option. The ATL script (or a previously loaded instrumentation script), may determine whether the web browser of the user computer system contains a system cookie, which contains a user ID. The script then extracts the user ID from the system cookie and forwards it to the session, component 60 along with the request to invite friends to the selected event. The session component 60 identifies the target user profile or the customer account associated with the provided user ID and retrieves contact information of friends of the identified user. The session component 60 in connection with the messaging component 55 then generates invitation messages and sends them to the friends of the user. Using one-click invitations, even information “virally” spreads among system users, which facilitates event promotion by attracting additional attendees to the promoted event.

Analytical Component

In an embodiment, the event management and promotion system 10 comprises an analytical component 95 operable to analyze the collected behavioral information of the system users in order to maximize reach, exposure and ultimately the success of promotional campaigns. In one embodiment, the analytical component 95 may be operable to determine target users' interest in the promoted events. In another embodiment, the analytical component 95 may be operable to identify target users who contributed to the distribution of the event information. Yet in another embodiment, the analytical component 95 may be operable to identify various relationships and patterns among target users. For example, the component 95 may identify maven and connector, users, as will be described herein, as well as clusters of users who share similar interests in events. The analysis of behavioral information of target user by the system 10 enables customers 15, such as event promoters, to improve their understanding of the target audience, expand their target user list, gain additional event attendees, provide target users with customized event promotions and offers based on the campaign analytics, maximize users loyalty by reducing unwanted emails sent to them, minimize cost of promotional campaign, maximize the desired make-up of the audience, as well as improve effectiveness, of future promotional campaigns,

In an embodiment, the analytical component 95 implements an interest algorithm to determine target user's interest level in a promoted event. According to the algorithm, the component 95 analyzes target user responses to the promotional message and advertisements to determine user' interest level. The factors that may be used to determine user interest include, but are not limited to, whether the user had viewed the promotional/invitation message, whether the user have, viewed the advertisement creative, whether the user have viewed the event webpage, whether the user have added the event to a calendar, whether the user have set an event reminder or whether user have invited friends to the event. Other factors that may contribute to determination of the user's interest in the event include, but are not limited to, time that the user spend reviewing the event webpage and user interaction with embedded media, including videos, image galleries, audio recordings and the like. In addition, the interest algorithm may account for loss of user interest over time; for example, a user who received a promotional message six months ago and took no action at that time may not have the same interest level in the event as someone who viewed the same message only recently. The interest algorithm may use other parameters in determining user's interest in the event.

In one embodiment, the analytical component 95 may implement an interest algorithm operable to organize target users into interest groups based on user responses to promotional messages or advertisements. For example, the interest algorithm may organize target users into three interest groups: low interest group, medium interest group and high interest group. For example, a target user may be placed into a low interest group if the user merely viewed, the received promotional message or event advertisement, but took no further action. A target user who has viewed the promotion message or event advertisement and then followed a hyperlink therein to view an event webpage may be placed into a medium interest group, because the user had expressed more interest in the event than the user who did not view the event webpage. The high interest group may include target users who have added the promoted event to a calendar, set event reminder or invited friends to the event, thereby expressing even more interest in the event than someone who have merely viewed the event webpage and, of course, more than someone who have only viewed the message. It is understood by those of skill in the art that in other embodiments the interest algorithm may organize users in fewer or more interest groups and based on different set of factors.

In another embodiment, the analytical component 95 may implement an interest algorithm operable to score target user interest level in the promoted event based on the user's response to a promotional message or event advertisement For example, the interest algorithm may use a multi-point scoring system, such as 1 to 5 or 1 to 100 point system, or even a non-integer scoring system. Alternatively, a percentage scale may be used to grade user interest level in the event. For instance, a 5-point scoring system may be used as follows: a target user who has viewed the received promotional message or event advertisement, but took, no further action may be assigned a score of one. A target user who has viewed the promotion message or event advertisement and then followed a hyperlink therein to view the event webpage may be assigned a score of two. A user who has either added the promoted event to a calendar or set an event reminder may be assigned a score of three. A user who has invited one or more friends to the event may be assigned a score of four. A user who has invited one or more friends to the event and either added the event to a calendar or set an event reminder may be assigned a score of five. In other embodiments, the interest algorithm may user a different scoring system, such as those that use fewer of more score points.

In an embodiment, the analytical component 95 is further operable to identify various relationships and patterns among target users. For example, the component 95 may identify maven and connector users. The maven users may be characterized by the following behavior: (i) they explore a lot of events of the same type, e.g., genre, performer, venue, etc., and (ii) they communicates this information to many friends who, once notified, also express interested in the events. In identifying maven users, the analytical component 95 may determine, for example, whether the number of friends of the target user who have expressed interest in the promoted event exceeds a certain threshold, e.g., 25 friends or more. The connector users may be characterized in the following manner: (i) they communicate with many users, (ii) they have a diverse set of interests, and (iii) they have a large and diverse set of friends. In identifying connector users, the analytical component 95 may determine, for example, whether the target user has expressed interest in a lot of different events and whether he communicated event information to friends whose number exceeds a certain threshold, e.g., 50 friends or more. In other embodiments, the connector and maven users may be identified using different sets of criteria and using different threshold values. The analytical component 95 may designate maven and connectors uses using, for example, descriptive category identifiers. Boolean expressions (true/false) as well as numeric influence scores, which identify the number of target users introduced to the event by the given maven or connector.

In one embodiment, the analytical component 95 is operable to identify various relationship and patterns among target users. For example, the component 95 may identify clusters of target users, such as groups of friends or unacquainted users, who share similar interest in one embodiment, the analytical component 95.may identify clusters of users based on the invitations and forwards of messages sent by the users. Thus, the analytical component 95 may analyze user responses to promotional/invitation messages and advertisements and generate a list of system user who have invited friends or have forwarded the original message. In another embodiment, once the system 10 collects a sufficient amount of behavioral information on system users, the analytical component 95 may refine the previously created cluster information by incorporating information about system users who frequently express Interest in events of the same type. Specifically, the analytical component may tags the identified target users with, an identifier of a particular cluster, thereby associating target users with each other as having similar interests. In addition, the analytical component 95 may identify maven and connector users within a cluster. Having identified a cluster of system users, customers 15 may target their promotional campaigns to the cluster of users thereby minimizing their promotional expenses and maximize impact of the promotional campaign.

Pricing Component

In an embodiment, the event management and promotion system 10 comprises a pricing component 85 operable to generate customized offers to target users 20 as well as to price event promotions for customers 15. In one embodiment, the pricing component 85 is operative to assist customers 15 to generate customized offers to the target users 20 based on the user interest level in the event. The interest level may be determined based on the target user's response to promotional/invitation messages and advertisement. Thus, target users who expressed high interest in the promoted event, such as the users in a high interest group or those with high interest scores, maybe offered better seats at higher prices than users who expressed less interest in the event, such as the users in a medium interest group or those with lower interest scores, in addition, the user with higher degree of interest in the event may be offered VIP event packages, while the user with lower degree of interest may be provided with free souvenirs, which would entice them into attending the promoted event. Furthermore, the pricing component 85 may facilitate that maven and connector users receive special offers, as expression of gratitude for spreading the promotional messages to a large number of friends.

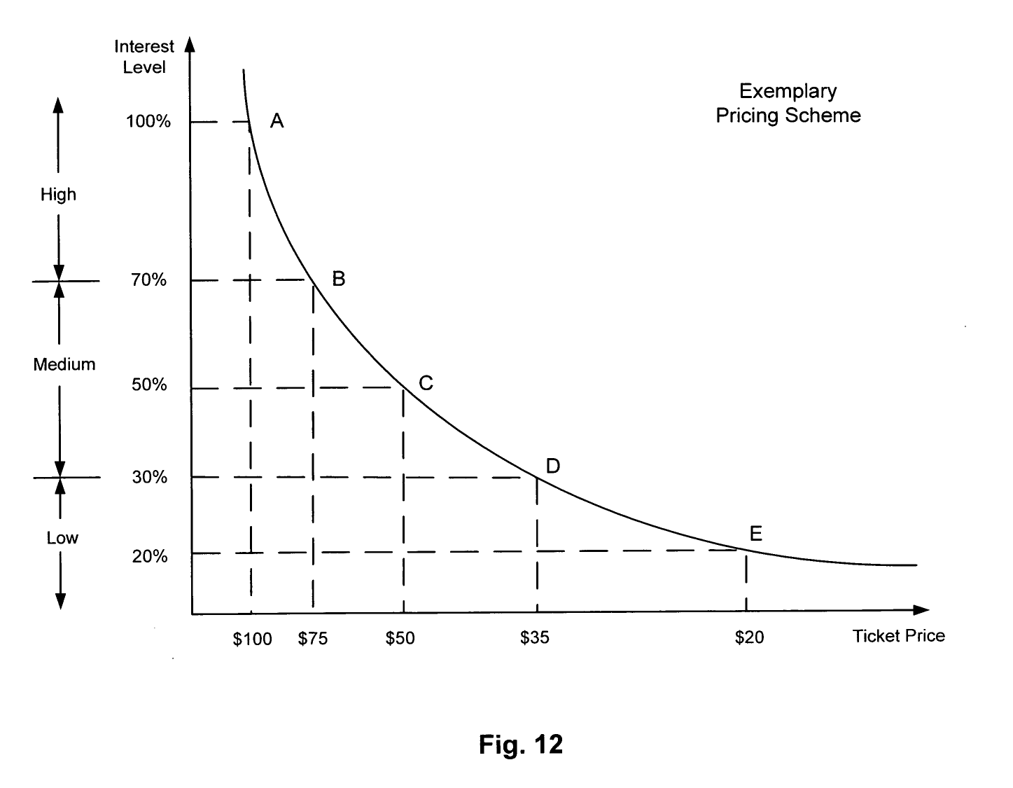

In general, a customer 15 may specify a variable pricing model to be utilized in connection with the pricing of promoted events. In turn, the pricing component 85 in connection with the messaging component 55 may generate customized offer messages based on the variable pricing model. An exemplary embodiment of the event pricing model is depicted in FIG. 12. As shown, the price, of an event may be directly related to the user interest in the event. In other words, as user interest in the event decreases, the price of admission to the event is reduced as well, thereby inducing the less interested Users in attending the event at a discounted price. For example, target users in the high interest group who have added an event to the calendar and invited, friends (point A), may be offered admission tickets at a regular price of S100 per ticket. Target users in the medium interest group who have either added the event to their calendars or set event reminders (point B), may be offered discounted tickets at $75 per ticket, while users in the same interest group who have only invited friends to the event (point C) may be offered admission tickets for only $50 per ticket. Lastly, users in the lowest interest group who have only viewed the event webpage (point D) may be offered admission tickets at a premium price of $35, while the users in the same interest group who have only viewed the promotional message may be offered admission tickets for merely $20. Those of skill in the art may recognize that the above pricing model is merely exemplary and there other pricing models that may be implemented in other embodiments.

In another embodiment, the pricing component 85 is operable to determine a price that is to be charged by the system 10 to customers 15 for promoting their events to target users and friends thereof. If a customer 15 wishes to run a promotional campaign to target users that are sot on the customer's contact list, the system 10 may facilitate promotion of customer events to system users for a price. The price for promoting events to target users may be based on user's interest in similar events, as well as user status, such as a maven or connector. To implement such a promotional campaign, the customer 15 may specify via interface component 40 one or more parameters characterizing the promoted event and the intended audience. For example, the customer 15 may specify such criteria as event genre, event venue, demographics of the intended audience or other factors. Having identified one or more target users that fit the customer-specified criteria, the pricing component 85 determines a price for promoting the event to the identified target users. In an embodiment, tire price for promoting event to target user who have previously expressed, high interest in similar events may be set higher than the price for promoting the event to users with low interest in similar events. Likewise, the price for promoting the event to connector and maven users may be set higher because these users are known, to facilitate further promotion of events to many friends. Alternatively, instead of pricing each user separately, the pricing component 85 may quote to the customer 15 a single bulk price for promoting event to a cluster of users who are known to share interest in similar events. Those of skill in the art may recognize that there are many different pricing schemes that may be implemented by the pricing component 85 in various embodiments of the system.

Accounting Component

In an embodiment, the event management and promotion system 10 comprises an accounting component 90, which provides a secure environment for performing financial transactions related to payment for promotion of customer events. In particular, the accounting component operable to provide a secure online environment, in which secure information, such as credit card or bank account information of customers 15, can be exchanged using various know encryption techniques. The accounting component 90 may establish, a secure connection between event management and promotion system 10 and customers computer system using SHTTP, SSL or any other cryptographic techniques known to those of skill in the art. Using the secure connection, the accounting component 90 is operable to collect credit, card payments from customers 15 for promoting events to target users and for other services of the system 10.

Reporting Component

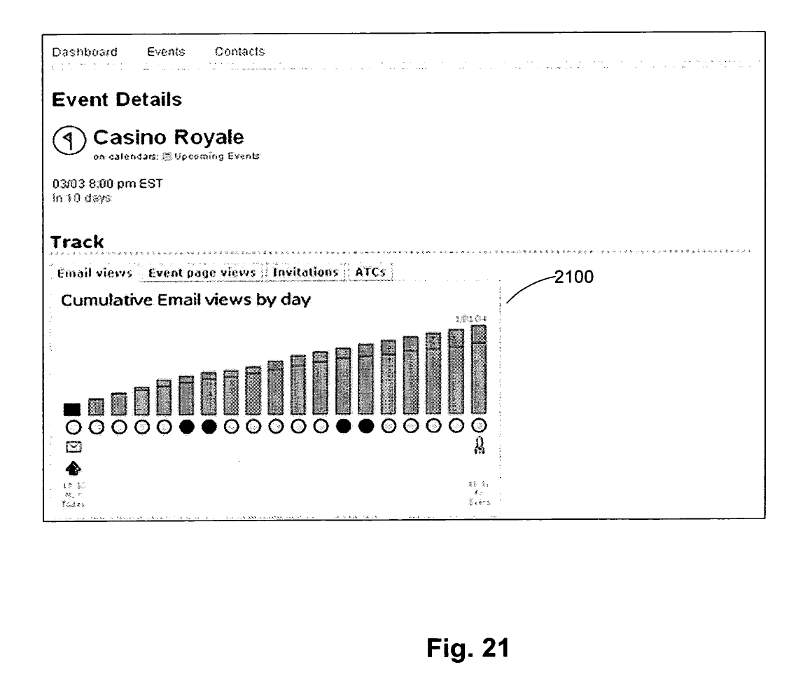

In an embodiment, the event management and promotion system 10 comprises a reporting component 65 operable to generate customized reports summarizing results of promotional and advertising campaigns; an exemplary reporting interface is depicted in FIG. 21. For each promoted event, the reporting component 65 may display to the customer 15 information on (i) the number of target users who have viewed event promotional messages, (ii) the number of users who have viewed event advertisements, (iii) the number of target users who have viewed event webpages, (iv) the number of target users who have added event to their personal calendars, (v) the number of target users who have set event reminders, and (vi) the number of target users who have invited friends to the event. In other embodiments, the reporting component 65 may provide information on the number of users who have attended the promoted event if such information is available to the system 10 as well as the information on the number, of users who subscribed to receive from the system 10 updates on events associated with particular performers or venues. The customer 15 may select a format in which the report data is displayed, such as daily, weekly or monthly chart.

In an embodiment, the report charts generated by the reporting component 65 may be actionable by the system users. With reference to FIG. 21, the reporting component 65 may generate an actionable chart 2100, which displays a daily distribution of the number of target users and friends thereof who have viewed promotional messages that were sent by the system in connection with an event promotional campaign. Having reviewed the actionable chart 2100, the customer 15 may, for example, click on the chart. In response, the reporting component 65 may generate a user menu, which provides the customer 15 with various options. One option may allow the customer 15 to view additional information about target users who have viewed the promotional message. Another option may allow the customer 15 to generate customized offer messages to the target users. Yet in another option, the system may identify connectors and mavens among target users. The customer 15 may select one of the menu options, and the system 10 will perform the customer's request.

Flow Charts

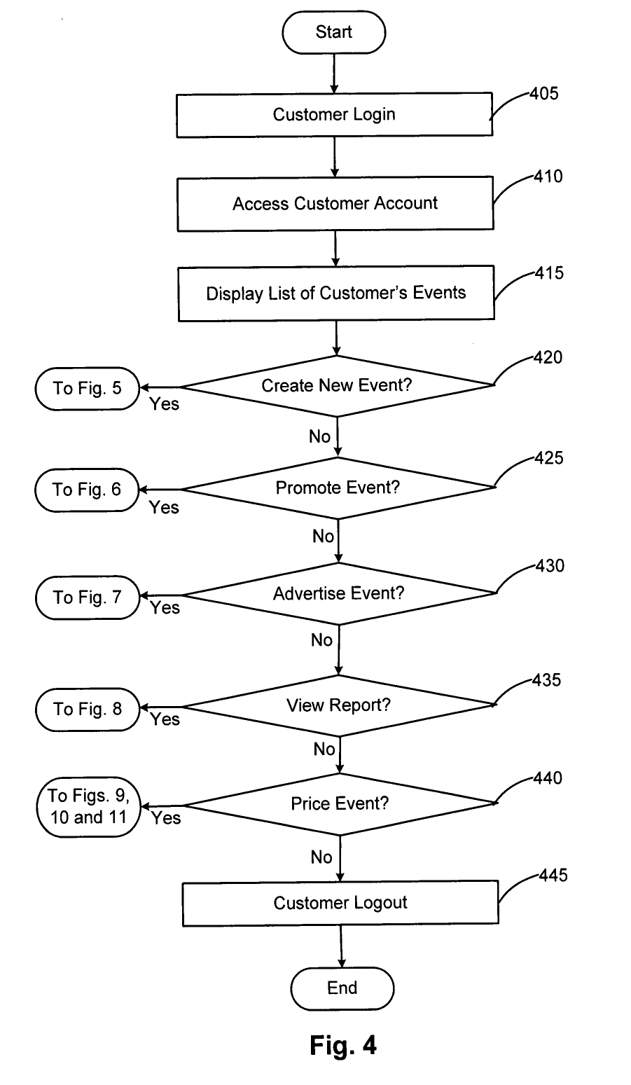

FIG. 4 depicts the high level operation of the customer interface of the event management and promotion system according to an embodiment of the invention. A system user, such as a promoter, may access the event management and promotional system by directing his web browser to the system website, which, in response, generates a customer login interface, step 405. Once customer login credentials, such as username and password, are provided and verified, an interface component of the event management and promotional system access customer account, step 410, and retrieves therefrom customer's even listings as well as promotional and advertising campaign information, step 415. For new users, the interface component is operable to sets up a new account and to display a new user welcome screen, winch may describe various features of the event management and promotional system and how to use them. The customer interface may then provide to the customer a plurality of options for creating, executing and managing promotional and advertising campaigns.

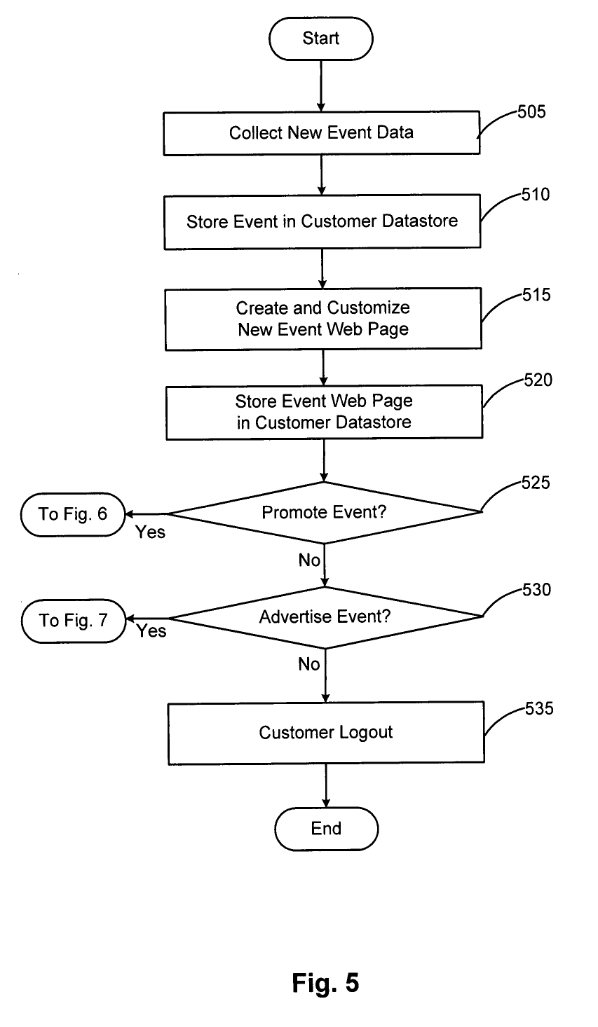

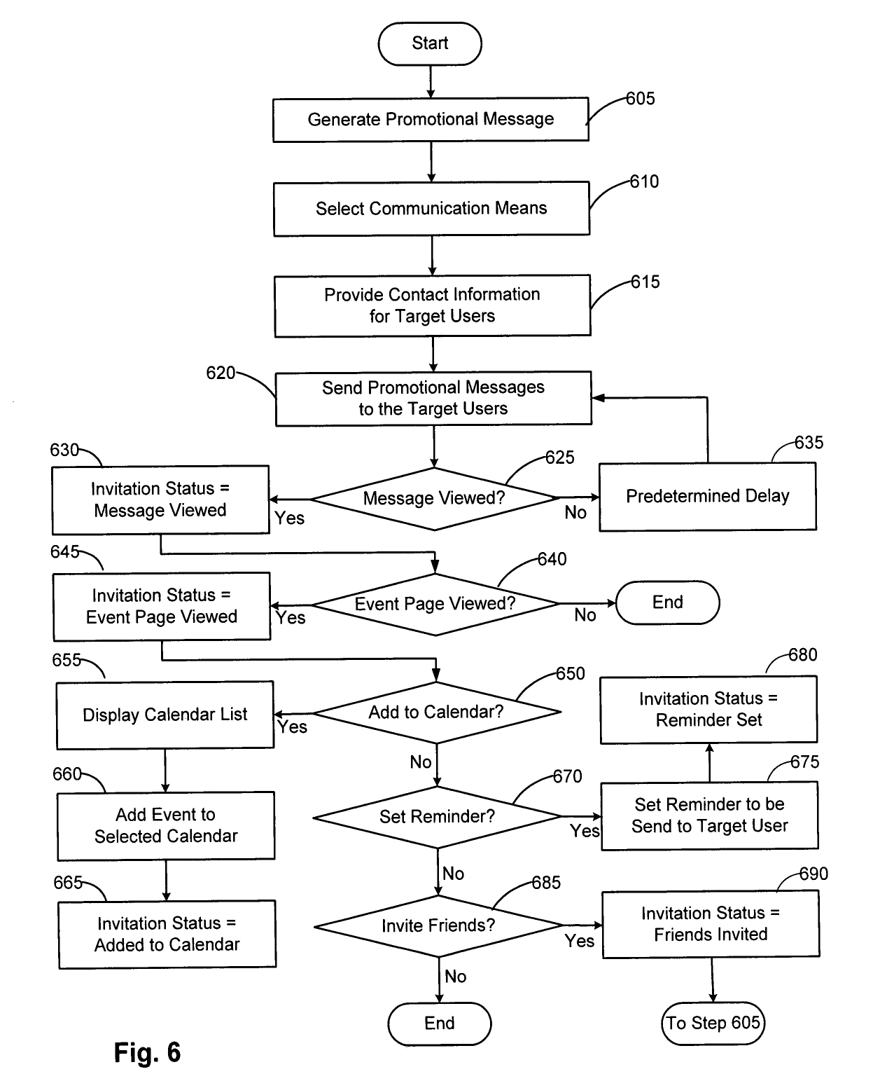

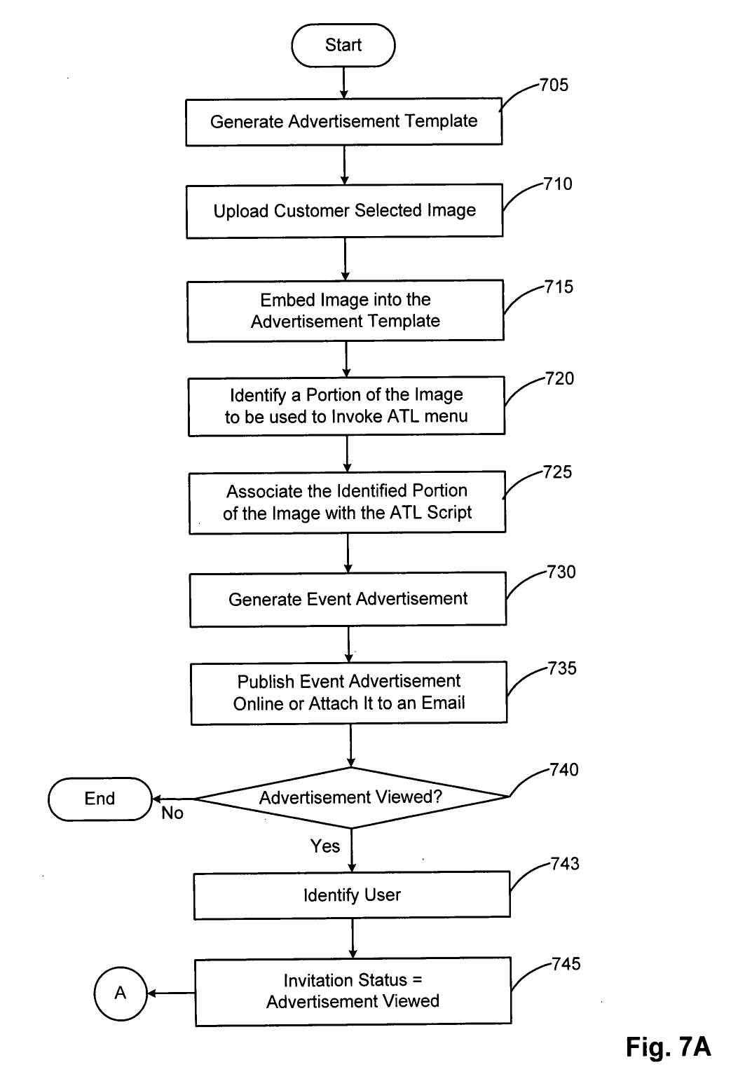

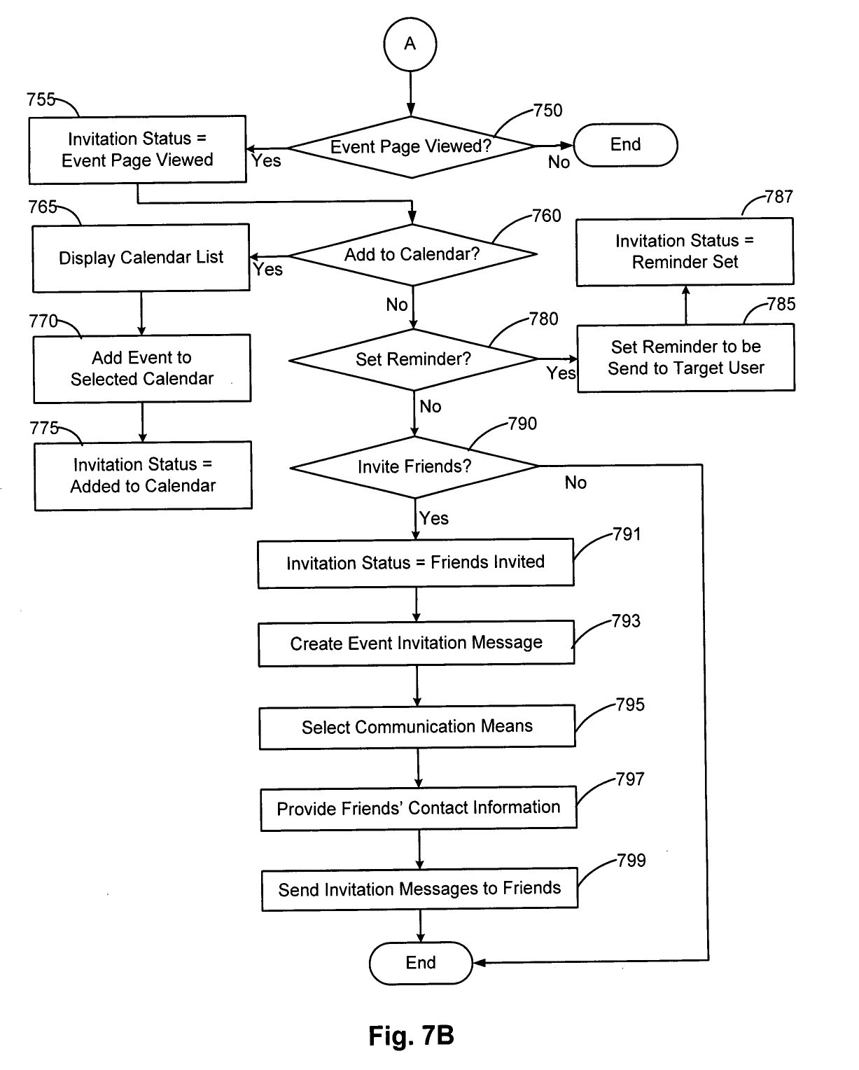

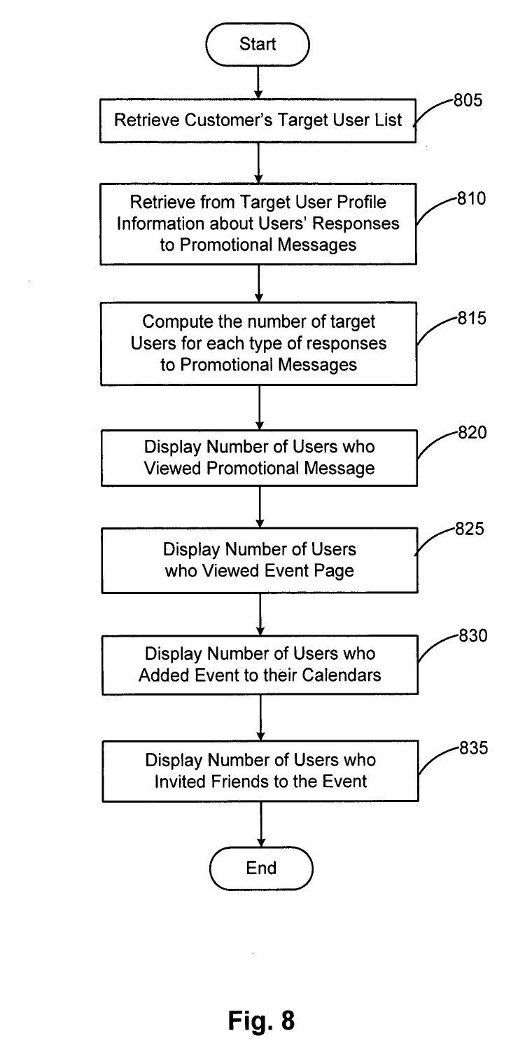

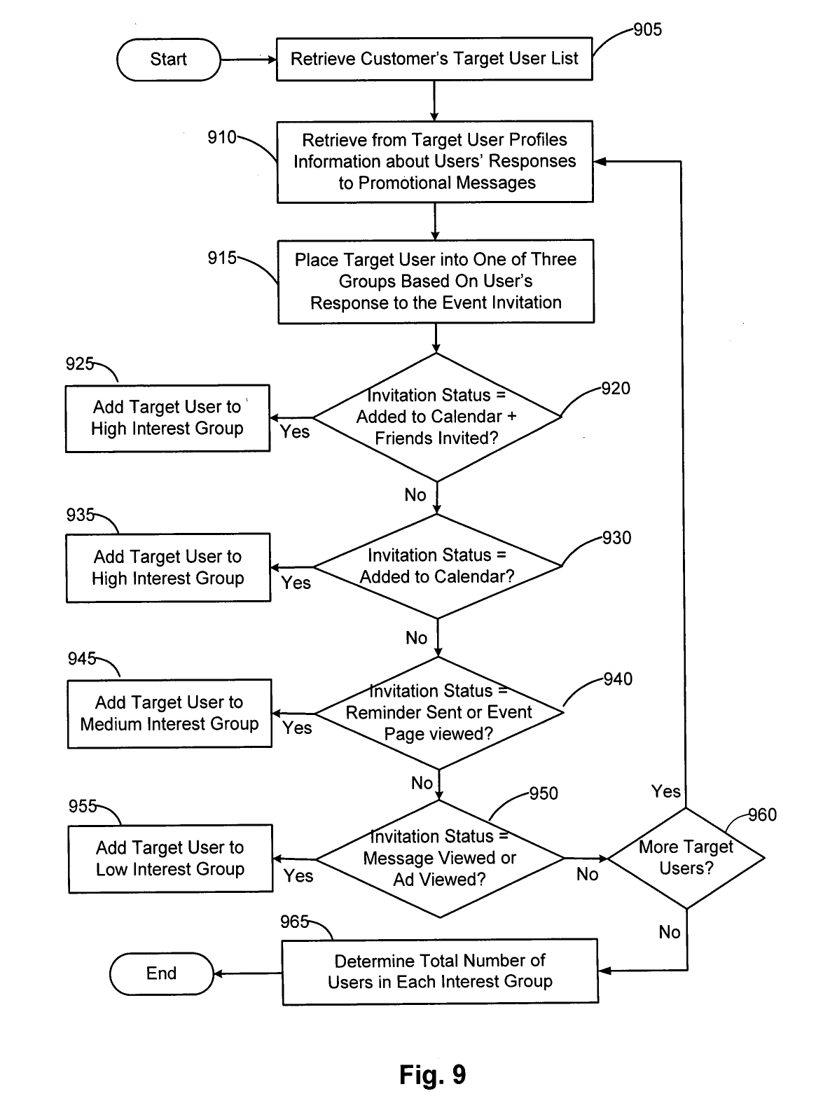

For example, at step 420, the interface component provides to the customer an option of creating new events and event webpages, which will be described in a greater detail herein with reference to FIG. 5. At step 425, the interface component provides an option of promoting a new or previously created-event, which will be described in a greater detail herein with reference to FIG. 6. At step 430, the interface component provides an option of advertising a new or previously created event, which will be described in a greater detail herein with reference to FIG. 7. At step 435, the interface component provides to the customer an option of viewing reports of execution of promotional campaigns, which will be described in a greater detail herein with reference to FIG. 8. At step 440, the interface component provides an option of pricing event promotion, which will be described in a greater detail herein with reference to FIGS. 9-11. Finally, when the customer finished using the event management and promotional system, the interface components logs the customer out of the system, step 445.

FIG. 5 is a flow diagram depicting an embodiment of a process for generating new events and event webpages, which facilitate promotion of customer events. As depicted, at step 505, the interface component provides a customer with an option to add new events to the customer account. When the customer selects this: option, the interface component may generate an interface for adding new events to the customer account. Through the interface, the customer may specify the title of the event, its start and end time/date, and location of the event. The customer may also provide a description of the event, upload an image associated with the event, such as a brand image or logo, or upload a multimedia clip associated with the event, such as an audio, video or Flash movie. The interface component then stores the collected event information in the customer account in the customer datastore, step 510.

The process may then be handed to the promotional component, which enables the customer to create event webpages, step 515. The even webpage may be generated from a HTML document template, which is populated with event information. The event webpage may include a title of the event, its date and time, a description of the event, comments entry field and a listing of posted comments, a map of the area where event will take place, and images, audio or video presentations associated with the event. In an embodiment, the event webpage may also include an ATL options menu, which may include the following options: set event reminder, invite friends and add to event a calendar. The promotional component then stores the event webpage in the customer datastore, step 520. The customer may then choose to promote the newly created event, at step 525, and/or advertises the event, step 530. When the customer has finished using the system, the customer may logout, step 535.

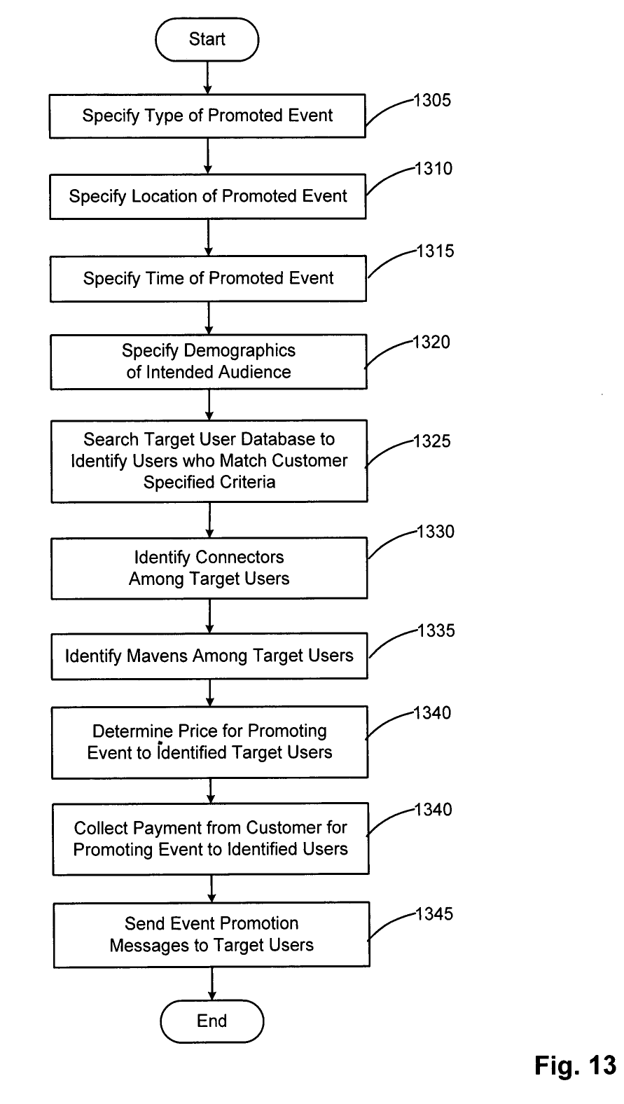

FIG. 6 is a flow diagram depicting an embodiment of a process for promoting an event and collecting behaviorally targeted leads data. As depicted, at step 605, the promotional component in connection with messaging component enables a customer to create a promotional message associated with the event. The customer may apply previously created message formats to the current promotional message; the customer may use message templates provided by the messaging component; or the customer may also upload his own HTML messages to be used for event promotion. The message may include a URL of the event webpage or a clickable advertisement of the event. At step 610, the customer may select means by which the promotional message is to he sent to target users, including email. Instant messaging, text messaging or other technologies. At step 615, the customer may specify the contact addresses of the target, user to which the messaging component should send the newly created promotional messages. Alternatively, the pricing component allows customer to purchase a contact list of target user, as will be described in a greater detail herein with reference to FIG. 13. The promotional message is then send to the target users, step 620.

Once a promotional message is receive by a target user, the session component may determine whether the message has been opened and viewed by the user, step 625. If the promotional message has not been viewed after a predetermined time period (e.g., 10 day), step 635, the promotional component may instruct messaging component to resend the promotional message to the target user, if the message has been viewed, the session component may set an Invitation status variable in the session history data structure of the target user profile to “message viewed” status or a similar status indicator, step 630. The invitation status variable may comprise an array of strings, or other type of container data structure know to those of skill in the art. If the session component then determines that the event page has been, viewed by the user, step 640, the invitation status variable in the session history data structure may be updated to include “event page viewed” indicator or a similar status indicator, step 645.

Once the event page is displayed to the target user, an embedded ATL script may generate an ATL menu, which provides the user with one or more of the following options: add event to calendar, set event reminder and invite friends. If the user selects add to calendar option, step 650, the ATL script generates a list of calendar applications, step 655. Once the user makes a calendar selection, the ATL script sends a message to the calendar component, which is operable to add event information to the selected calendar using, step 660. The session component changes the invitation status to include “added to calendar” indicator, step 665. If the user chooses to set an event reminder, step 670, the ATL script sends a message to that effect to the promotional component, which sets a reminder message to be send to the target user shortly before the event data, step 675. The session component changes the invitation status variable to include “reminder set” indicator, step 680. Lastly, if the user chooses the invite friends option, step 685, the script sends a message to that effect to foe session component, which changes the invitation status variable to include “friends invited” Indicator, step 680. The process flow then cycles back to step 605, at which the ATL script enables the target user to create and send invitation message to friends.

FIG. 7 is a flow diagram depicting an embodiment of a process for advertising an event and collecting behaviorally targeted leads data. As depicted, at step 705, the advertisement component generates an advertisement template, such as a markup language document, which contains an ATL script embedded therein or an HTML tag operable to retrieve an ATL script from the session component when advertisement is loaded into the user' web browser. To create an advertisement, the customer may upload an advertisement image, step 710, which will be embedded into the advertisement, step 715. The customer may also identify a section of the image which, would activate the ATL menu, upon an action from a user, such as a click of the mouse, step 720. The advertisement component then associates the ATL functionality with the selected section of the advertisement creative, step 725. The advertisement component then generates an advertisement creative, step 730. The advertisement then may be published on the Web via various advertising channels, such as DoubleClick.com, or sent to target users in promotional messages, step 735.

Next, the system using session component may determine whether the advertisement creative has been viewed, step 740. For example, the session component may receive a request from the HTML tag in the advertisement creative or a message from the embedded ATL scrip, which indicates that advertisement has been viewed. The session component may then use user ID or other aforementioned techniques to identify whether the advertisement viewer is a registered system user, step 743. Having identified the user, the session component may the set an invitation status variable in the session history data structure of the target user profile to “advertisement viewed” status or a similar indicator, step 745. If the advertisement contains a link to the event webpage, and the viewer has activated such a link to view the event webpage, step 750, the session component may update the invitation status to include “event page viewed” indicator or a similar status indicator, step 755.

If the advertisement viewer activates the embedded ATL menu, the system may collect additional information about user behavior. If the user selects add to calendar option. step 760, the ATL script generates a list of calendar applications, step 765. Once the user makes a calendar selection, the ATL script sends a message to the calendar component, which is operable to add event information to the selected calendar using, step 770. The session component changes the invitation status to include “added to calendar” indicator, step 775. If the user chooses to set event reminder, step 780, the ATL script sends a message to that effect to the promotional component, which sets a reminder message to be send to the user shortly before the event data, step 785. The session component changes the invitation status variable to include “reminder set” indicator, step 787. If the user chooses the invite friends option, step 790, the script sends a message to that effect to the session component, which changes the invitation status variable to include “friends invited” indicator, step 791. The system then enables the user to create invitation message, step 793, select communication means, step 795 and provide friends' contact information, step 797. The system then sends invitation messages to the identified friends.

FIG. 8 is a flow diagram depicting an embodiment of a process for reporting results of a promotional campaign. Upon customer request, the reporting component retrieves from the customer datastore customer's target user list for the given promotional or advertising campaign, step 805. The reporting component then retrieves from target user profiles of the users on the customer's list information about users' responses to promotional messages (and/or event advertisements), step 810. The reporting component then computes the number of users for each type of response, step 815. In particular, the reporting component may compute (i) the number of target users who have viewed a promotional message send, (ii) the number of target users who have viewed an event advertisement, (iii) the number of target users who have viewed an event webpage, (iv) the number of target users who have added the event to a calendar, (v) the number of target users who have set event reminder, and (vi) the number of target users who have invited one or more friends to the event. The reporting component then displays to the customer several charts indicating the computed number of users who expressed interest in the promoted event, steps 820, 825, 830 and 835.

FIG. 9 is a flow diagram depicting one embodiment of an interest algorithm of the event management and promotion system. At step 905, the analytical component retrieves from the customer account customer's target user list. The analytical component then retrieves from target user profiles of the users on the customer's list information about users' responses to promotional messages (and/or event advertisements), step 910. The analytical component organizes target users into three interest groups based on user responses, step 915. To that end, the analytical component retrieves from a target user profile information stored in a invitation status variable. If the invitation status is equal to “add to calendar” and “invite friends” status, step 920, the target user may be placed into a high interest group, step 925. If the invitation status is equal to “added to calendar” status, step 930, the target user may be also placed into the high interest group, step 935. If the invitation status is equal to “reminder sent” or “event webpage viewed” status, step 940, the target user may be placed into a medium interest group as well, step 945. If the invitation status is equal to “message viewed” or “advertisement viewed” status, step 950, the target user may he placed into a low interest group, step 955. The analytical component then determines if there are more target users in the customers target user list, step 960 and repeats steps 910-950. The analytical component then computes the total number of users in each interest group, step 965.

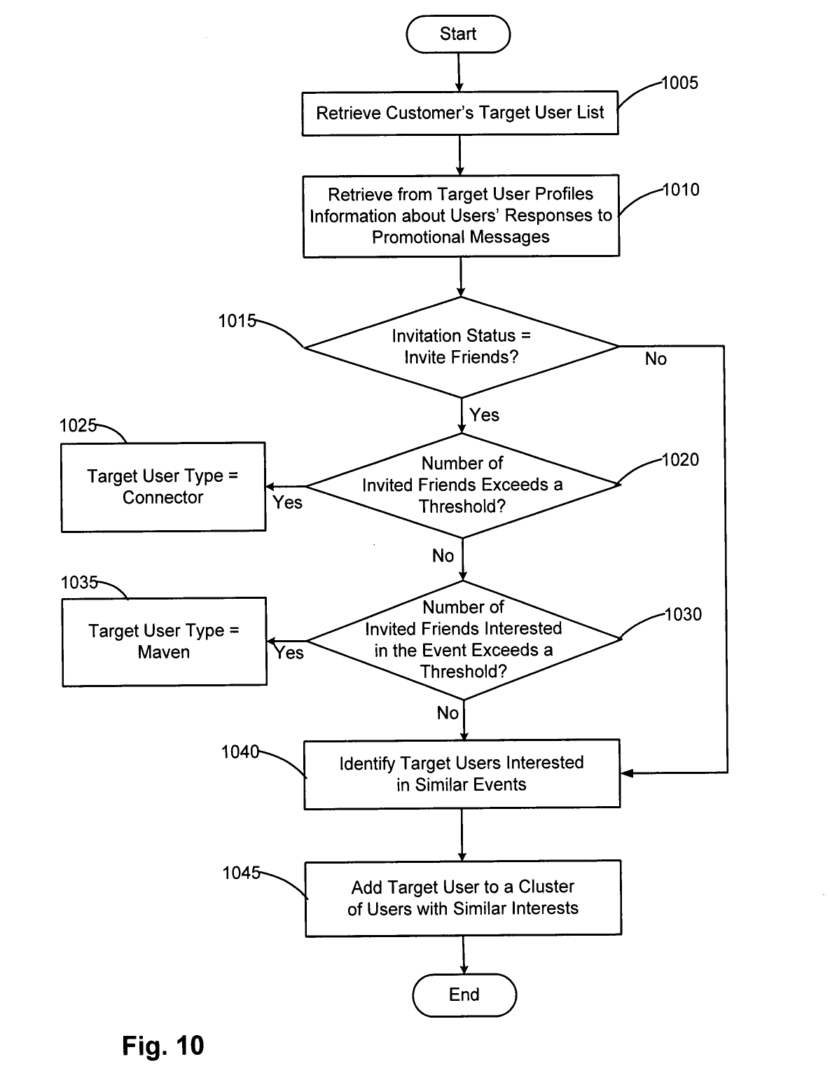

FIG. 10 is a flow diagram depicting another embodiment of tire interest algorithm of the event management and promotion system. At step 1005, the analytical component retrieves from a customer account the customer's target user list. The analytical component then retrieves from target user profiles of the users on the customer's list information about users' responses to promotional messages (and/or event advertisements), step 1010. If the invitation status is equal to “invite friends” status, step 1015, the analytical component determines whether the number of friends of the target user exceeds a predetermined threshold, step 1020. If this determination is affirmative, the analytical component sets the value of target user type variable to include “connector”, step 1025. The analytical component then determines whether the number of friends of the target user who have expressed interest in the promoted event exceeds a certain threshold, step 1030. If this determination is affirmative, the analytical component updates the value of the target user type to include “maven,” step 1035. The analytical component then searches target user profile in the target user datastore, to identify target users who have also expressed interest in the same event (or similar events based on genre, performer, venue or other parameters), step 1040. The analytical component then adds target user to a cluster of users having similar interest, step 1045. Specifically, the analytical component may tags the identified target users with an identifier of a particular cluster, thereby associating target users with each other as having similar interests.

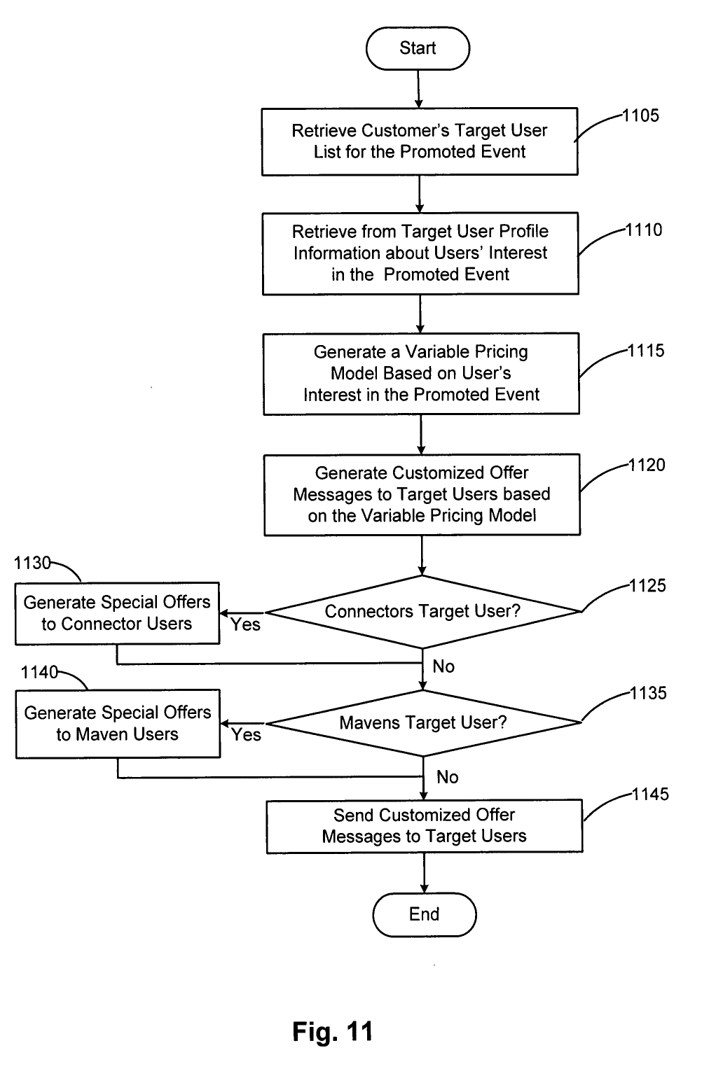

FIG. 11 is a flow diagram depicting a process for interest-based event pricing, which may be implemented in an embodiment of the event management and promotion system. At step 1105, the pricing component retrieves from a customer account customer's target user list. The pricing component then retrieves from the target user profiles of the users on the customer's list information about users' interest in the promoted event, such as an identifier of the interest group to which the user is assigned, step 1110. The interest level may be determined by analytical component based on the target user's response to the event promotional messages and advertisements, as described above. The pricing component then enables the customer to specify a variable pricing model to be utilized in connection with the pricing of promoted events, step 1115. An exemplary embodiment of the event pricing algorithm is depicted in FIG. 12 and described in a greater detail hereinabove.

The pricing component then allows the customer to generate custom offer messages based on the specified variable pricing model, step 1120. Thus, target users who have expressed high interest in the promoted event, such as the users in a high interest group or those with high interest scores, may be offered better seats at a higher price than users who have expressed less interest in the event, such as the users in a medium interest group or those with lower interest scores. In addition, the user with higher degree of interest in the event may be offered VIP event packages, while user with lower degree of interest may be provided with free souvenirs, which would entice them into attending the promoted event. The pricing component then searches for connectors among target users, step 1130. If one or more target user are identified as connector, the pricing component allows customer to generate special offer messages to these users, step 1135. The pricing component then searches for mavens among target users, step 1140. If one or more target users are identified as mavens, the pricing component allows customer to generate special offer messages to maven users, step 1135. The messaging component is then instructed to sends the customized oiler messages to target users.

FIG. 13 depicts a process for target user search and targeted event promotion according to an embodiment of the event management and promotion system. In particular, the customer may use the interface component of the system to search target user profiles for target users who would be interesting in receiving event promotions. The search may be conducted using one or more parameters characterizing the promoted event and the intended audience. As depicted, the customer 15 may specify the type of the promoted event, step 1305, the location of the promoted event, step 1310, the time/date of the promoted event, step 1315, and the demographics of intended audience, step 1320. The interface component will conduct such a search of the target user profiles, step 1325. Having identified one or more target users that match the customer-specified search criteria, the customer may request the interface component to identify connectors and mavens among identified target users, steps 1330 and 1335. The pricing component then determines a price for promoting the event to the identified target users, step 1340. For example, the price for promoting event to target user who have previously expressed higher interest in the similar events may be set higher than the price for promoting the event to users with lower interest in the similar events. Likewise, the price for promoting the event to connector and maven users may be set higher because these users are known to facilitate further promotion of the event to numerous friends. Having quoted the price to the customer, the accounting component may collect from the customer the requested payment amount, step 1340. The customer may then use the messaging component of the system to create promotional messages and send them to the identified target users, step 1345.

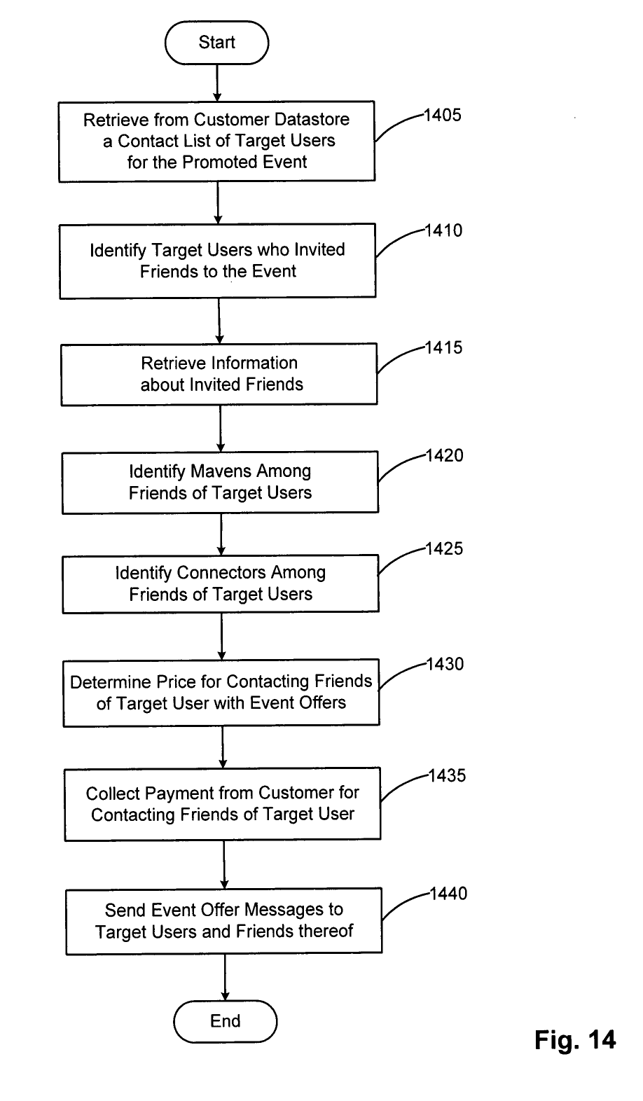

FIG. 14 depicts a process for targeted event promotion according to another embodiment of the event management and promotion system. At step 1405, the interface component retrieves from a customer account customer's target user list. Using target user profiles of the users on the customer's list, the interface component identifies target users who invited friends to the promoted event, step 1410. The interface component then retrieves from target user profiles of the invited friends information about friends' responses to the invitation messages, such as information on whether invited friends have invited their friends, forwarded the invitation messages to other users, added the event to their calendars or set reminders, step 1415. The interface component then identified mavens and connectors among the invited friends, steps 1420 and 1425. The system then activates the pricing component, which determines a price for contacting the friends of the target users with event offers, step 1430. For example, the price for contacting friends of the target users who have expressed higher interest in the promoted event may be set higher than the price for contacting friends with lower interest in the event. Likewise, the price for promoting the event to connector and maven friends may be set higher because these users are known to facilitate event promotion. Having quoted the price, the accounting component may collect from foe customer the requested payment amount, step 1435. The customer may then use the messaging component to create and send customized offer messages to target users and friends thereof, step 1440.

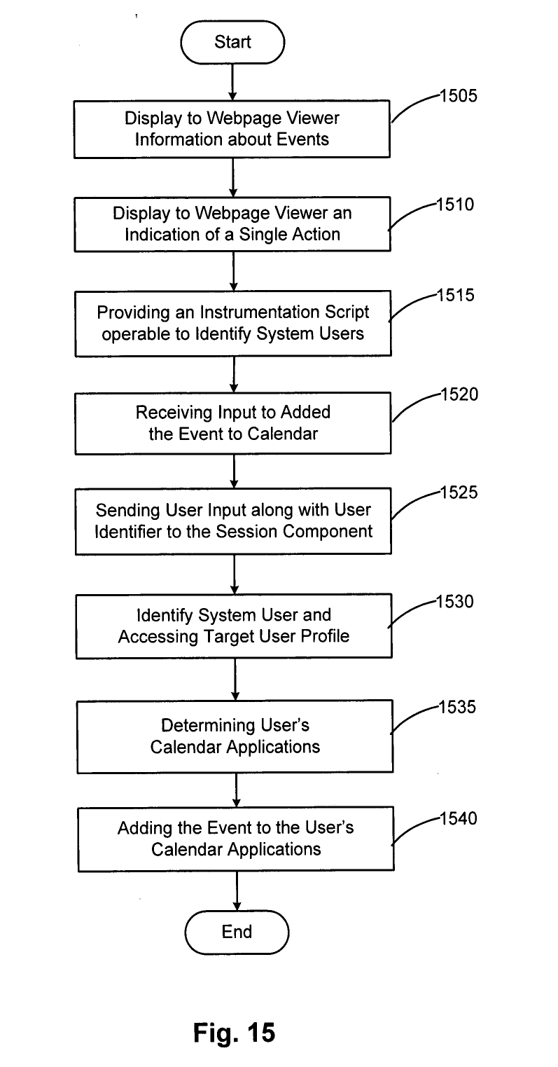

FIG. 15 depicts a process for one-click event sharing according to an embodiment of the event management and promotion system. At step 1505, an embedded system component, such as an embedded calendar or event widget displays to a webpage viewer (i.e., user) information about one or more promoted events. At step 1510, the component may display an indication of a single action that is to be performed by the user to add an identified event to a user calendar, such as an ATL menu or Add to Calendar button. The system may also provide to the user's computer system an instrumentation script operable to identify system users, step 1515. For example, the instrumentation script may locate a system cookie or a browser cookie, stored in the user's computer system memory, which contains a unique user identifier assigned by the system. The embedded component is operable to detect the single action being performed by the user, step 1520, and, in response, send a request to the session component of the event management and promotional system to add the identified event to one or more user calendars. The request may be accompanied by foe user identifier, step 1525. Once the request is received by the session component the system identities the system user based on the provided user identifier and access a target user profile of the identified system user, step 1530. From the target user profile, the session component identifies one or more user's calendar applications, step 1535. The user calendar applications may include, but are not limited to, system-provided event widget embedded by the user into third-party websites; online calendar hosted by the calendar component; system-provided calendars embedded by the user into third-party websites; and third-party calendar applications. Having identified user's calendar applications, the calendar component updates the identified calendar applications with the user-selected even information, step 1540. Thereby, the new even information will automatically appear on the user calendar applications and thus may be viewed by other viewers or added to their own calendars by means of ATL functionality.

FIGS. 1-21 are conceptual illustrations allowing an explanation of the present invention. It should be understood that various aspects of the embodiments of the present invention could be implemented in hardware, firmware, software, or a combination thereof. In such an embodiment, the various components and/or steps would be implemented in hardware, firmware, and/or software to perform the functions of the present invention. That is, the same piece of hardware, firmware, or module of software could perform one or more of the illustrated blocks (e.g., components or steps). Unless explicitly stated otherwise herein, the ordering or arrangement of the steps and/or components should not be limited to the descriptions and/or illustrations hereof.

In software implementations, computer software (e.g., programs or other instructions) and/or data is stored on a machine readable medium as part of a computer program product, and is loaded into a computer system or other device or machine via a removable storage drive, hard drive, or communications interface. Computer software can be implemented by any programming or scripting languages, such as Java, JavaScript. Action Script, or the like. Computer programs (also called computer control logic or computer readable program code) are stored in a main and/or secondary memory, and executed by one or more processors (controllers, or the like) to cause the one or more processors to perform the functions' of the invention as described herein.

Notably, the figures and examples above are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that, are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). Moreover, it is not intended for any term in the specification or claims to be ascribed an uncommon or special meaning unless explicitly set forth as such. Further, the present invention encompasses present and future known equivalents to the known components referred to herein by way of illustration. While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for sharing event information, the method comprising:
providing to a client system a user identifier;
providing to the client system a script operable to (i) display information identifying one or more events and (ii) display an indication of a single action that is to be performed to add an event to one or more calendars;
in response to the single action being performed by a user of the client system, receiving from the script (i) a request to add an identified event to one or more calendars associated with the user of the client system, and (ii) the user identifier;
identifying the one or more calendars associated with the user of the client system based at least on the received user identifier; and
adding the identified event to one or more identified calendars.

2. The method of claim 1, wherein the user identifier contains one or more of (i) information identifying the user and (ii) information identifying the client system.

3. The method of claim 1, wherein the user identifier comprises a web cookie.

4. The method of claim 1, wherein the single action comprises one of
(i) the user clicking of a mouse button when a cursor is positioned over a predefined area of the displayed event information;
(ii) the user depressing of a key on a keyboard; and
(iii) the user depressing of a key on a television remote control

5. The method of claim 1, wherein a calendar comprises a listing of events organized in one of daily format, weekly format, monthly format, yearly format and chronological order.

6. The method of claim 5, wherein a calendar comprises one or more of (i) an online calendar hosted by the server system, (ii) a calendar script provided by the server system and embedded by the user into a third-party website, and (iii) an calendar application provided to the user by a third party.

7. A method for sharing event information, the method comprising:
displaying at a client system information identifying an event;
displaying an indication of a single action that is to be performed by a user to add the identified event to one or more calendars; and
in response to only the indicated single action being-performed by the user, sending to a server system a request to add the identified event to one or more calendars.

8. The method of claim 7 further comprising obtaining from the client system a user identifier and sending the user identifier to the server system along with the request to add the identified event to one or more calendars.

9. The method of claim 7, wherein the user identifier contains one or more of (i) information identifying the user and (ii) information identifying the client system.

10. The method of claim 7, wherein the user identifier comprises a web cookie.

11. The method of claim 7, wherein the single action comprises one of
(i) the user clicking of a mouse button when a cursor is positioned over a predefined area of the displayed event information;
(ii) the user depressing of a key on a keyboard; and
(iii) the user depressing of a key on a television remote control.

12. The method of claim 7, wherein a calendar comprises a listing of events organized in one of daily format, weekly format, monthly format, yearly format and chronological order.

13. The method of claim 12, wherein a calendar comprises one or more of (i) an online calendar hosted by the server system, (ii) a calendar script provided by the server system and embedded by the user into a third-party website, and (iii) an calendar application provided to the user by a third party.

14. A system for sharing event information, the system comprising:
a client component operative
to display information identifying one or more events,
to display an indication of a single action that is to be performed by a user to add an identified event to one or more user calendars.
in response to the single action being performed by the user, to send a request to add the identified event to one or more user calendars, wherein the request includes a user identifier; and
a server component operative
to receive the request from the client component,
to identify the one or more user calendars based at least on the user identifier,
to add the identified event to one or more user calendars.

15. The system of claim 14, wherein the client component comprises an instrumentation script.

16. The system of claim 14, wherein the client component is executable by a browser of user's computer system.

17. The system of claim 16, wherein the user identifier contains one or more of (i) information identifying the user and (ii) information identifying the user's computer system.

18. The system of claim 14, wherein the user identifier comprises a web cookie.

19. The system of claim 14, wherein the single action comprises one of
(i) the user clicking of a mouse button when a cursor is positioned over a predefined area of the displayed event information;
(ii) the user depressing of a key on a keyboard; and
(iii) the user depressing of a key on a television remote control.

20. The system of claim 14, wherein a calendar comprises a listing of events organized in one of a daily format, weekly format, monthly format, yearly format and chronological order.

21. The system of claim 20, wherein a calendar comprises one or more of (i) an online calendar hosted by the server component, (ii) a calendar script provided by the server component and embedded by the user into a third-party website, and (iii) an calendar application provided to the user by a third party.
